(19) United States
(12) Patent Application Publication
(10) Pub. No.: US 2016/0004708 A1
(43) Pub. Date: Jan. 7, 2016

(54) FILE STORAGE APPARATUS AND DATA MANAGEMENT METHOD

(71) Applicant: HITACHI, LTD., Chiyoda-ku, Tokyo (JP)

(72) Inventors: Nobumitsu TAKAOKA, Tokyo (JP); Shoji KODAMA, Tokyo (JP)

(73) Assignee: Hitachi, Ltd., Chiyoda-ku, Tokyo (JP)

(21) Appl. No.: 14/769,688

(22) PCT Filed: Jun. 7, 2013
(86) PCT No.: PCT/JP2013/065829

§ 371 Date: Aug. 21, 2015

(51) Int. Cl. G06F 17/30; G06F 11/14

(52) U.S. Cl. CPC G06F 17/30073; G06F 17/3023; G06F 17/30144; G06F 11/1446

(57) ABSTRACT

A file storage stores a client file (a file from a client) in a first file system (FS), stores metadata of the client file in a backup file in a second FS, and backs up the backup file to the first FS at a backup process start time. The file storage creates consistency file management information specifying a backup file having been backed up and a client file at that time point, acquires, when a file specified by the consistency file management information is transmitted to an archive storage apparatus, data identification information for identifying the transmitted file in the archive storage apparatus, and associates the data identification information with the transmitted file.

### TECHNICAL FIELD

The present invention relates to a technique for archiving files.

### BACKGROUND ART

Data is managed by computer systems utilized by corporations in increasingly large amounts. In consideration thereof, various data management methods for maintaining or managing data are being proposed and utilized. Known examples of data management methods include data archiving (hereinafter, also referred to as archiving) and data backup (hereinafter, also referred to as backup).

Data archiving is a data management method used in a business environment where business data is successively generated to stably manage a utilization rate of storage capacity of storage (primary storage) that stores the business data. With data archiving, business data with low reference frequency among the business data is migrated from the primary storage to a storage (secondary storage) having a lower operating cost. Accordingly, a utilization rate of primary storage capacity is kept within a constant range. After business data is transferred to the secondary storage, the business data can be referenced via an interface provided by the secondary storage. In addition to the purpose of maintaining the utilization rate of the storage capacity of the primary storage, data archiving is also used for the purposes of long-term storage of business data, secondary utilization of data, and the like. Therefore, data archiving is performed on the premise that no changes are to be made on data stored in the secondary storage.

Archive storages that are specially designed to be utilized as secondary storages are being widely used. For example, a certain archive storage provides an API for storing an entire file as a transaction in one operation as an interface for storing files. In addition, the archive storage is provided with a function (version management function) which enables, when a previously stored file is overwritten and stored, contents of the file before being overwritten to be referenced by specifying a version of the file.

Furthermore, a technique described in PTL 1 is known as a technique for data archiving to be implemented in a primary storage. With the archive system described in PTL 1, a primary storage periodically copies files stored in the primary storage to an archive storage. In addition, the primary storage manages a frequency of use of a stored file and automatically replaces a file whose use frequency has declined with a stub file. This series of processes realizes automatic data archiving. In this case, a stub file refers to a temporary file that stores a link to a copied filed in the archive storage. When an access is made to the stub file, the primary storage replaces the stub file with data already copied to the archive storage and restores the data. An advantage of this technique is that even an archived file can still be referenced as a file of the primary storage without having a user make an inquiry to the secondary storage.

On the other hand, data backup is a data management method for continuing business operations though a disaster. With data backup, a consistent state at a certain time point of active business data in a primary storage is copied to a dedicated backup storage as backup data. When business data is lost from the primary storage due to a disaster or the like, the business data is restored in the primary storage from the copied backup data. Accordingly, business interrupted by the disaster can be continued using the restored business data.

Examples of techniques related to data backup intended for files include a technique described in PTL 2. With this technique, a primary storage that is a client of a backup server records differential information created by updating of respective files as a plurality of differential files and collectively transmits the differential files to the backup server at a backup timing.

Meanwhile, data storages mounted with interfaces specially designed for specific business fields are also being used as primary storages. For example, PACS (Picture Archiving and Communication Systems) that implement a DICOM (Digital Imaging and COmmunication in Medicine) protocol designed for accumulating and viewing medical images are used in the field of medicine and content management systems mounted with vendor-unique, web-based interfaces are used in offices. These systems regularly include a database system for file management. For example, while the DICOM protocol defines specifications for referring to desired image data by specifying a patient ID, an inspection date, and the like, a PACS apparatus is generally configured to record data for promptly responding to such search requests in a database included in the PACS apparatus.

With backup of such primary storages intended for specific business fields, backup of the included database is necessary in addition to the managed files.

### CITATION LIST

### Patent Literature

### [PTL 1]

### Japanese Patent Application Publication No. 2010-009573

### [PTL 2]

### Japanese Patent Application Publication No. 2005-292905

### SUMMARY OF INVENTION

### Technical Problem

With a primary storage intended for a specific business field, when restoring data from backup data, there must be consistency between the database to be restored and the file. In other words, when restoring the database, a file managed by the database must be restored in a state that is consistent with a state recorded in the database. In addition, since a primary storage intended for a specific business is also a primary storage in which business data is successively accumulated, data archiving is desirably applied.

However, independently executing data archiving and data backup results in increasing data management cost. From the perspective of amounts of storage use, since copies are doubly made in the form of archive data and backup data, storage cost increases. In addition, from the perspective of data management, since data archiving and data backup are to be respectively managed, operation cost increases.

Since both data archiving and data backup involve copying data in a primary storage to another storage, if archive data can also be utilized as backup data, a reduction in storage cost can be achieved. In addition, by performing data backup together with data archiving, operation cost can be reduced.

Therefore, a data backup technique in a form that can be added onto a data archiving function is desirably realized.

Enabling archive data created in an archive storage to be utilized as backup data requires a technique that offers solutions to the following three problems: restoring a group of files in a consistent state at a certain time point from archive data; restoring a database to a state of a time when the state of the group of files was correctly recorded; and enabling these operations to be performed in a form that can be added onto an existing data archiving function.

However, with the technique described in PTL 1, when a file is copied from the primary storage to an archive storage, each file is copied without any consideration to an update order of the file. Therefore, there is no guarantee that archive data constructed in the archive storage matches a state at any time of files stored in the primary storage. As a result, it is impossible to retrieve a group of files in a state of a certain time since there is no way of knowing which files are included at that time and what kind of state the contents of the files are in.

On the other hand, with the technique described in PTL 2, since a difference creation time is described in differential data to be transmitted to a secondary storage, backup data can be constructed while securing an update order. However, the technique described in PTL 2 cannot be implemented in a form that can be added on to an existing archiving function. This is because adding on to an existing archiving function means that an entity to transmit differential data is the archiving function and not the backup function and that time information cannot be added to data to be transmitted by this entity.

In consideration thereof, an object of the present invention is to realize a technique for enabling archive data created in an archive storage to be utilized as backup data.

### Solution to Problem

A file storage includes a first file system (first FS) and a second file system (second FS) storing a database including a database file. The file storage stores a client file (a file received from a client computer) in the first FS and stores metadata of the client file in the database file (DB file). The file storage creates transmission file management information that specifies a file to be transmitted for archiving to the archive storage apparatus among a plurality of files which are stored in the first FS and which include a client file and a database file. The file storage performs an archiving process in which a file specified by the transmission file management information is transmitted to the archive storage at a prescribed archiving process start time. In addition, the file storage performs a backup process in which a backup file of the database is backed up in the first FS at a prescribed backup process start time. The file storage creates consistency file management information that specifies a backup file backed up in the first FS and a client file in the first FS at a time point when the backup file is backed up in the first FS. The file storage monitors a file transmitted by an archive processing unit to an archive storage apparatus, acquires, when a file specified by the consistency file management information is transmitted to the archive storage apparatus, data identification information for identifying the file transmitted to the archive storage apparatus at the archive storage apparatus, and associates the acquired data identification information with the file specified by the consistency file management information.

### Advantageous Effects of Invention

Information can be managed which can specify, in an archive storage, data necessary for appropriately restoring a file to a consistent state at a prescribed time point. Therefore, a file can be restored to a consistent state at a prescribed time point using archived data.

### BRIEF DESCRIPTION OF DRAWINGS

FIG. 1 is a diagram for explaining an outline of a computer system according to an embodiment.

FIG. 2 is a configuration diagram of a computer system according to an embodiment.

FIG. 3 is a diagram for explaining a logical structure of a file system and a database according to an embodiment.

FIG. 4A is a configuration diagram of an example of a file management table according to an embodiment.

FIG. 4B is a configuration diagram of an example of a metadata table according to an embodiment.

FIG. 5A is a configuration diagram of another example of a file management table according to an embodiment.

FIG. 5B is a configuration diagram of another example of a metadata table according to an embodiment.

FIG. 6A is a configuration diagram of an example of archiving history according to an embodiment.

FIG. 6B is a configuration diagram of an example of backup history according to an embodiment.

FIG. 7A is a configuration diagram of an example of an archiving schedule according to an embodiment.

FIG. 7B is a configuration diagram of an example of a backup schedule according to an embodiment.

FIG. 8 is a configuration diagram of an archive storage according to an embodiment.

FIG. 9A is a configuration diagram of an archive data storage area according to an embodiment.

FIG. 9B is a configuration diagram of an example of a version management table according to an embodiment.

FIG. 10 is a diagram for explaining an outline of a transmission list creating process according to an embodiment.

FIG. 11A is a configuration diagram of an example of a file according to an embodiment.

FIG. 11B is a configuration diagram of another example of a file according to an embodiment.

FIG. 12 is a flow chart of a backup process according to an embodiment.

FIG. 13 is a configuration diagram of an example of a consistency list according to an embodiment.

FIG. 14 is a flow chart of a consistency list creating process according to an embodiment.

FIG. 15 is a flow chart of an archiving process according to an embodiment.

FIG. 16 is a flow chart of a file receiving process according to an embodiment.

FIG. 17 is a flow chart of a file transmission monitoring process according to an embodiment.

FIG. 18 is a flow chart of a file update monitoring process according to an embodiment.

FIG. 19A is a configuration diagram of an example of a consistency list after a backup process is ended according to an embodiment.

FIG. 19B is a configuration diagram of an example of a completion flag according to an embodiment.

FIG. 20 is a flow chart of a restoring process according to an embodiment.

FIG. 21 is a configuration diagram of an archive schedule setting screen according to an embodiment.

FIG. 22 is a configuration diagram of a backup schedule setting screen according to an embodiment.

FIG. 23 is a configuration diagram of an archiving history display screen according to an embodiment.

FIG. 24 is a flow chart of an archiving history displaying process according to an embodiment.

FIG. 25A is a configuration diagram of an example of an image list display screen according to an embodiment.

FIG. 25B is a configuration diagram of another example of an image list display screen according to an embodiment.

FIG. 25C is a configuration diagram of an example of a bibliographic information display screen according to an embodiment.

FIG. 26A is a flow chart of a bibliographic information displaying process according to an embodiment.

FIG. 26B is a flow chart of an archiving/backup state determining process according to an embodiment.

### DESCRIPTION OF EMBODIMENTS

An embodiment will now be described with reference to the drawings. It should be noted that the embodiment described below is not intended to limit the invention as set forth in the accompanying claims and that all of the elements and combinations thereof described in the embodiment are not necessarily essential to solutions of the invention.

While information according to the present invention will be described below using expressions such as an “aaa table”, such information may be expressed using concepts other than data structures such as a table. Therefore, in order to demonstrate that information is not dependent on data structure, an “aaa table” and the like may sometimes be referred to as “aaa information”. Furthermore, while a “name” or an “ID” is used as identification information, other types of identification information may be used.

In addition, while a “program” is sometimes used as a subject when describing a process in the following description, since a program causes a prescribed process to be performed by appropriately using a storage resource (such as a memory) and/or a communication interface when being executed by a processor (such as a CPU (Central Processing Unit)), a “processor” may be used instead as a subject of a process. A process described using a program as a subject may be considered to be a process performed by an apparatus including a processor. Furthermore, a hardware circuit may be included which performs a part of or all of the processes to be performed by a processor. A computer program may be installed in an apparatus from a program source. The program source may be, for example, a program distribution server or a storage medium that can be read by a computer.

Furthermore, in the following description, when describing elements (for example, database (DB) files) of a same type without distinction, a parent number of a reference character (for example, 112) may be used, and when describing elements of a same type while distinguishing among the elements, an entire reference character (for example, 112a) may be used.

First, an outline of a computer system according to an embodiment will be described.

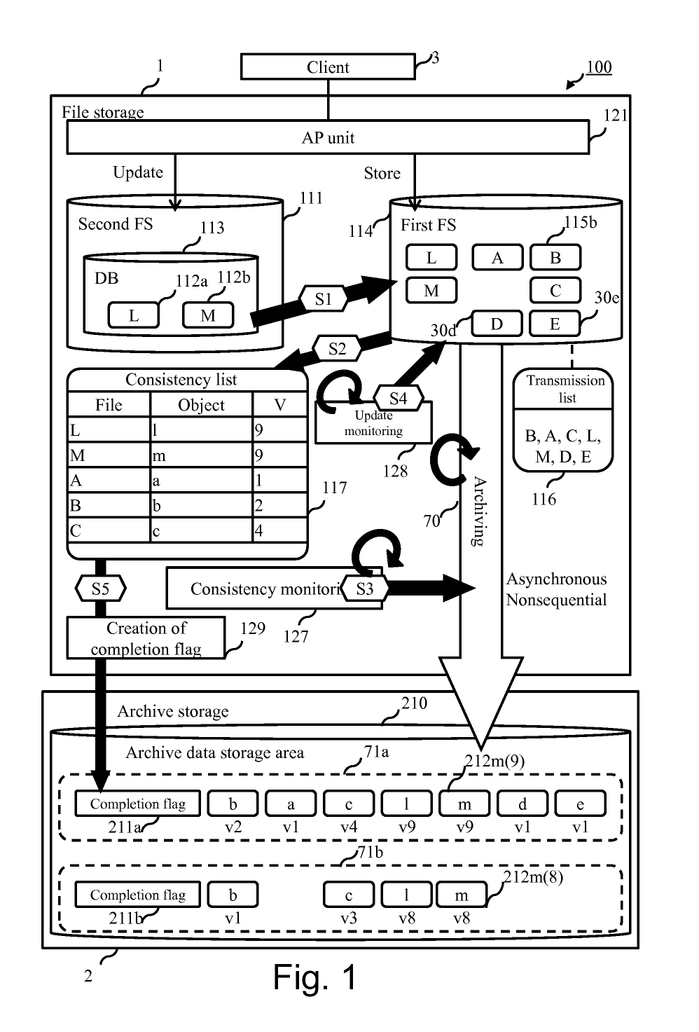

FIG. 1 is a diagram for explaining an outline of a computer system according to the embodiment.

A computer system 100 includes a file storage 1 and an archive storage 2. The file storage 1 and the archive storage 2 are respectively a type of a physical (or virtual) storage apparatus. The file storage 1 and the archive storage 2 are coupled to be capable of communicating with each other. In addition, the computer system 100 includes a client 3 which writes and reads data (typically, an electronic file) to and from the file storage 1. The client 3 is a physical (or virtual) computer.

The file storage 1 has at least two types of file systems including a first file system 114 (a file system may also be referred to as an FS) and a second FS 111. The second FS 111 is an FS of a backup source and the first FS 114 is an FS of a backup destination. The second FS 111 stores, for example, a DB (database) 113. The DB 113 is constituted by a plurality of DB files 112 (for example, two DB files 112a and 112b).

Furthermore, the file storage 1 includes an application unit (AP unit) 121, a consistency monitoring unit 127, an update monitoring unit 128, and a completion flag creating unit 129.

In the file storage 1, the AP unit 121 receives a file (for example, a file containing business data) together with data that supplements the file (referred to as metadata) from the client 3, stores the file in the first FS 114, and stores the metadata in the DB 113 (any of the plurality of DB files 112a and 112b constituting the DB 113) of the second FS 111.

The file storage 1 periodically executes an archiving process in which a file stored in the first FS 114 is stored in the archive storage 2 (refer to arrow 70). In this case, a path name of a target file that is transmitted from the file storage 1 to the archive storage 2 in the archiving process is registered in a transmission list 116 (transmission file management information). Moreover, a timing of transmitting a time may be out of synchronization with (may differ from) a timing of storing the file in the first FS 114, and a transmission order of files registered in the transmission list 116 may be in no particular order or may not be an order of storage of the files in the first FS 114. In an archiving process, the file storage 1 can archive a transmission target file in an archive data storage area 210 included in the archive storage 2 by transmitting a write command of the file which specifies the archive data storage area 210 to the archive storage 2. The archive data storage area 210 may be a physical storage device or a logical storage device (for example, a logical volume provided by the archive storage 2). Rectangles drawn by dashed lines and having rounded corners in the archive data storage area 210 represent information ranges corresponding to files stored in one archiving process. In addition, blocks with lowercase alphabet letters in the archive data storage area 210 correspond to blocks (files) with uppercase alphabet letters. Hereinafter, a file in the archive data storage area 210 may sometimes be particularly referred to as an “object”. Furthermore, a numeral described below an object (for example, 211m (9)) represents a version number of the object.

The file storage 1 executes a backup process at a prescribed time point. In the backup process, the file storage 1 staticizes the DB 113 and copies the DB files 112 (in FIGS. 1, 112a and 112b) in the second FS 111 to the first FS 114 (S1 in FIG. 1). Next, the file storage 1 creates a consistency list 117 (an example of consistency file management information) that is a list of a group of files in the first FS 114 at that time point or, in other words, a group of files with consistency (S2 in FIG. 1). Moreover, during a period from S1 to S2, the file storage 1 stops FS updates (addition and update of files to the second FS 111 and the first FS 114) by the AP unit 121.

The consistency monitoring unit 127 monitors transmission of files to the archive storage 2 and detects whether or not all files registered in the consistency list 117 have been transmitted to the archive storage 2 by inspecting, when detecting an already-transmitted file, whether or not the file is registered in the consistency list 117 (S3 in FIG. 1). In addition, in parallel with S3, the update monitoring unit 128 detects that files in the first FS 114 are updated by the AP unit 121 (S4 in FIG. 1). Update of files is detected at this point because, once a file is updated, consistency in backup data can no longer be guaranteed. Moreover, when a file is updated, the file storage 1 repeats processes from S1.

When the consistency monitoring unit 127 detects that all files in the consistency list 117 have been transmitted by the archiving process without being updated, the completion flag creating unit 129 creates a completion flag 211 (for example, 211a) that is an example of completion information based on the consistency list 117 and causes the archive storage 2 to store the completion flag 211 so as to be stored in association with the files stored by the archiving process (S5 in FIG. 1).

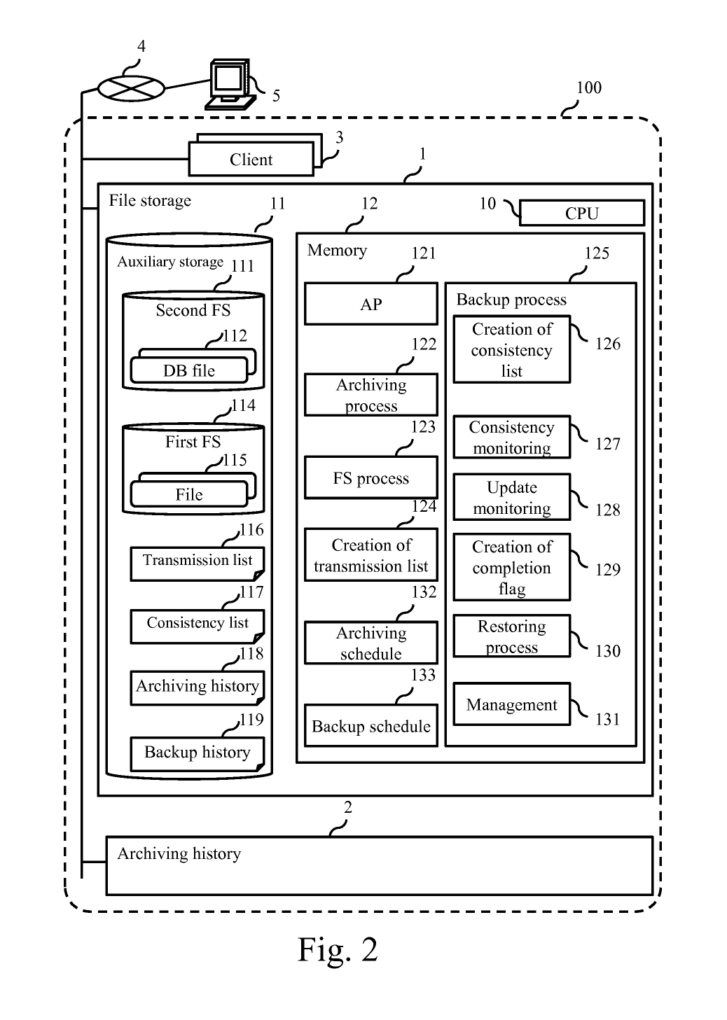

FIG. 2 is a configuration diagram of a computer system according to the embodiment.

As described earlier, the computer system 100 includes the file storage 1, the archive storage 2, and the client 3. The client 3 may exist in plurality. The file storage 1, the archive storage 2, and the client 3 are connected to be capable of data communication via a wired or wireless communication network (a PCI bus, a LAN, a WAN, the Internet, or the like). In addition, the computer system 100 is connected to a computer 5 that is an external management terminal via a communication network 4 so as to be capable of data communication. While the present embodiment will be described using an example where the file storage 1 and the archive storage 2 are respectively configured as independent physical computers, the file storage 1 and the archive storage 2 may respectively be independent virtual computers or may be realized by a single physical computer or a single virtual computer. In addition, while a function referred to as an “XX unit” is assumed to be realized by the execution of a computer program by a CPU in the present embodiment, all of or a part of at least one function may be realized by a hardware circuit.

The file storage 1 is a computer and includes a communication interface device (not shown), a storage device (for example, a memory 12 and an auxiliary storage 11), and a CPU 10 connected to these devices.

The communication interface device is an interface device for communicating with the client 3, the management terminal 5, and the archive storage 2.

The CPU 10 executes various processes by executing a program stored in the memory 12. In FIG. 2, various functional units that are realized by the CPU 10 by executing a program stored in the memory 12 are displayed in the memory 12 for the sake of brevity. Specifically, by executing a program stored in the memory 12, the AP unit 121, an archive processing unit 122, a file system processing unit 123, a transmission list creating unit 124, and a backup processing unit 125 are configured in the file storage 1.

The AP unit 121 is a functional unit that is realized by executing an application program (for example, a medical image accumulating program (medical image management system) or an enterprise content management system (content management system)). The AP unit 121 receives a file from the client 3, receives metadata of the file, stores the file in the first FS 114, and stores the metadata in the DB 113.

The archive processing unit 122 periodically executes an archiving process in which a file stored in the first FS 114 is stored in the archive storage 2. The file system processing unit 123 executes various processes on the second FS 111 and the first FS 114. The transmission list creating unit 124 creates a list (transmission list 116) that sets files stored in the first FS 114 as transmission targets to the archive storage 2. The backup processing unit 125 executes a backup process for backing up files.

The backup processing unit 125 includes the consistency list creating unit 126, the consistency monitoring unit 127, the update monitoring unit 128, the completion flag creating unit 129, a restore processing unit 130, and a managing unit 131. The consistency list creating unit 126 creates the consistency list 117 that is a list of a group of files for which consistency can be secured between the DB 113 and the files 115 at a prescribed time point. The consistency monitoring unit 127 monitors transmission of files and detects whether or not all files described in the consistency list 117 have been transmitted to the archive storage 2 by inspecting, when detecting an already-transmitted file, whether or not the file is registered in the consistency list 117. The update monitoring unit 128 detects that files in the first FS 114 are updated by the AP unit 121. When the consistency monitoring unit 127 detects that all files in the consistency list 117 have been transmitted without being updated, the completion flag creating unit 129 creates a completion flag and causes the archive storage 2 to store the completion flag. The restore processing unit 130 executes a restoring process for restoring the DB 113 and the files. The managing unit 131 executes processes for displaying various screens and the like. Although “display” as used herein means displaying information on the management terminal 5 that is connected to the file storage 1 (transmitting information that is a display target to the management terminal 5), “display” may mean that the file storage 1 includes a display device and information is to be displayed on the display device.

The memory 12 stores programs for configuring the respective functional units and various types of information. For example, the memory 12 stores an archiving schedule 132 and a backup schedule 133. The archiving schedule 132 stores schedule information for executing an archiving process by the archive processing unit 122. The backup schedule 133 stores schedule information for executing a backup process by the backup processing unit 125.

The auxiliary storage 11 is one or more nonvolatile storage devices such as one or more HDDs (Hard Disk Drives). The first FS 114 and the second FS 111 are constructed in the auxiliary storage 11.

The auxiliary storage 11 stores the transmission list 116, the consistency list 117, an archiving history 118, and a backup history 119. The transmission list 116 is a list of target files to be transmitted to the archive storage 2. The consistency list 117 is a list of a group of files for which consistency can be secured between the DB 113 and the files 115 at a prescribed time point. The archiving history 118 is information representing a history of archiving processes. The backup history 119 is information representing a history of backup processes.

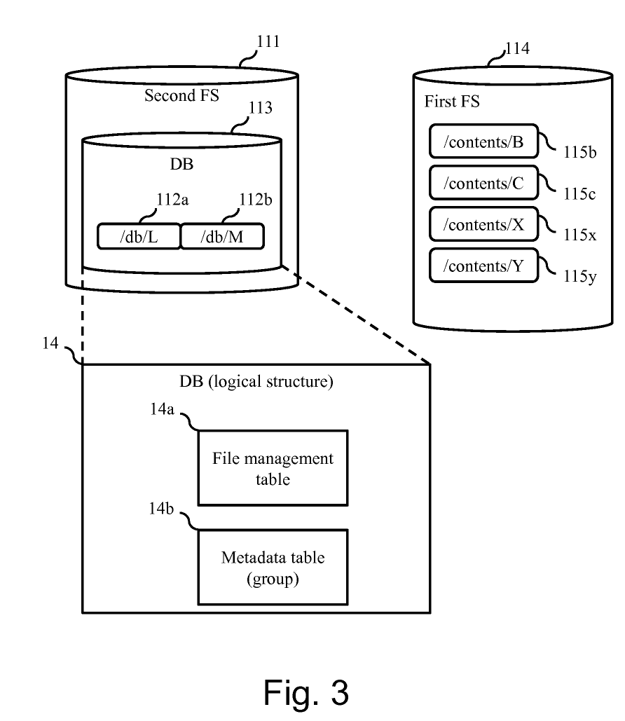

FIG. 3 is a diagram for explaining logical structures of an FS and a DB according to the embodiment.

As the files 115, the first FS 114 stores, for example, files 115b, 115c, 115x, and 115y which are identified by file paths /contents/B, /contents/C, /contents/X, and /contents/Y.

As the DB files 112 that constitute the DB 113, the second FS 111 stores the DB files 112a and 112b that are identified by file paths /db/L and /db/M. The DB 113 is a database for managing the files 115 stored in the first FS 114. Data stored in the DB files 112a and 112b are respectively configured by a known data structure such as a hash table, a B-tree, and the like and constitute a logical file management database 14. The file management database 14 includes a file management table 14a that manages files and a metadata table 14b that manages metadata of the files.

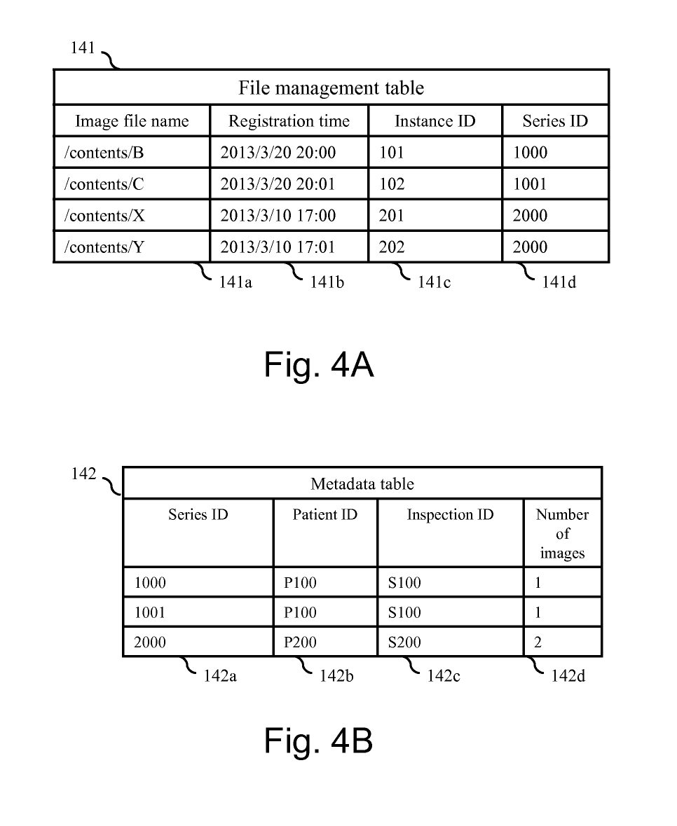

FIG. 4A is a configuration diagram of an example of a file management table according to the embodiment. FIG. 4B is a configuration diagram of an example of a metadata table according to the embodiment. The file management table 141 and the metadata table 142 shown in FIGS. 4A and 4B are examples of the file management table 14a and the metadata table 14b when the AP unit 121 functions as a medical image management system.

In this case, it is assumed that the files 115b, 115c, 115x, and 115y are files (image files) of medical images (X-ray images or the like).

The file management table 141 includes columns of an image file name 141a, a registration time 141b, an instance ID 141c, and a series ID 141d. The image file name 141a stores a file path of an image file. The registration time 141b stores a time (registration time) of registration of the image file. The registration time is also a time of update of an entry in the metadata table 142 corresponding to an image file of an entry for which the registration time is stored. The instance ID 141c stores an ID (instance ID) used by the AP unit 121 to internally identify an image file (instance). The series ID 141d stores a series ID corresponding to the image file. The series ID will be described later. The series ID is a key (external reference key) when referring to an entry of the metadata table 142 corresponding to an entry of the file management table 141.

The metadata table 142 includes columns of a series ID 142a, a patient ID 142b, an inspection ID 142c, and the number of images 142d. The series ID 142a stores an ID (series ID) for identifying a series that is a group of a series of images (for example, a group of images obtained when a plurality of images are taken by one photography session of a CT scanner) created when inspecting a patient. The patient ID 142b stores an ID for identifying a patient who is a target of an image. The inspection ID 142c stores an ID for identifying the inspection performed to acquire an image. The number of images 142d stores the number of images included in a series.

The metadata table 142 shown in FIG. 4B reveals that, for an inspection 5100 with respect to a patient P100, there is one image in a series 1000 and one image in a series 1001, and for an inspection 5200 with respect to a patient P200, there are two images in a series 2000.

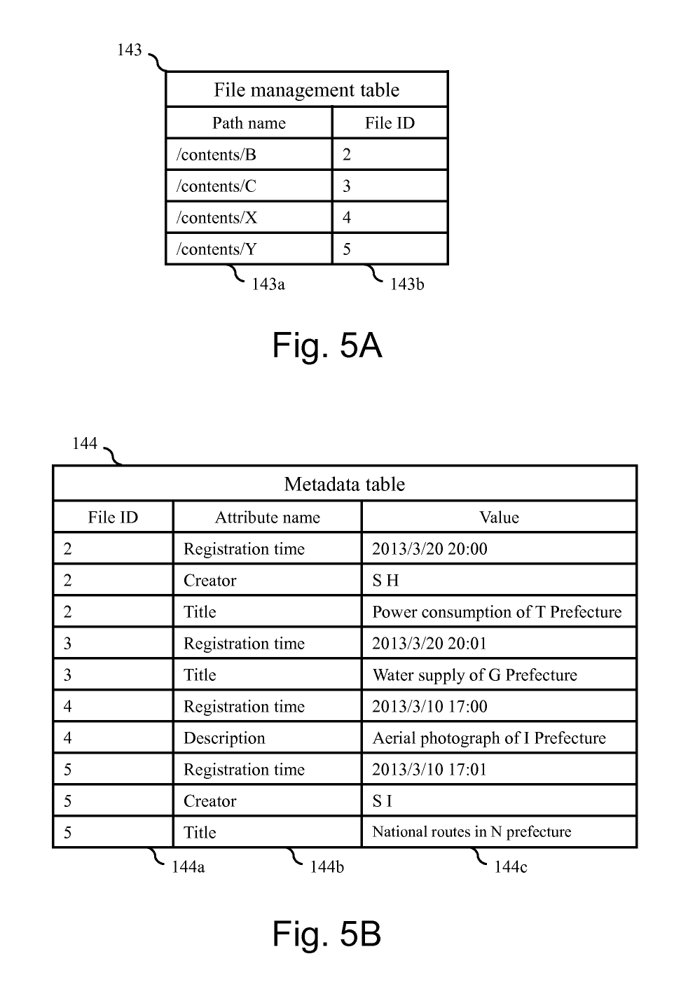

FIG. 5A is a configuration diagram of an example of a file management table according to the embodiment. FIG. 5B is a configuration diagram of an example of a metadata table according to the embodiment. The file management table 143 and the metadata table 144 shown in FIGS. 5A and 5B are examples of the file management table 14a and the metadata table 14b when the AP unit 121 functions as a content management system.

The file management table 143 includes columns of a path name 143a and a file ID 143b. The path name 143a stores a file path of a file of a content (content file). The file ID 143b stores an ID (file ID) for identifying a content file.

The metadata table 144 is a table for managing attributes of files and includes columns of a file ID 144a, an attribute name 144b, and a value 144c. The file ID 144a stores a file ID of a file. The attribute name 144b stores a name of an attribute. The value 144c stores a value of an attribute corresponding to an attribute name of an entry.

According to the file management table 143, a file expressed as /contents/B has a file ID of 2, and according to the metadata table 144, a registration time of the file is 2013/3/20 20:00, a creator of the file is SH, and a title of the file is “power consumption of T prefecture”.

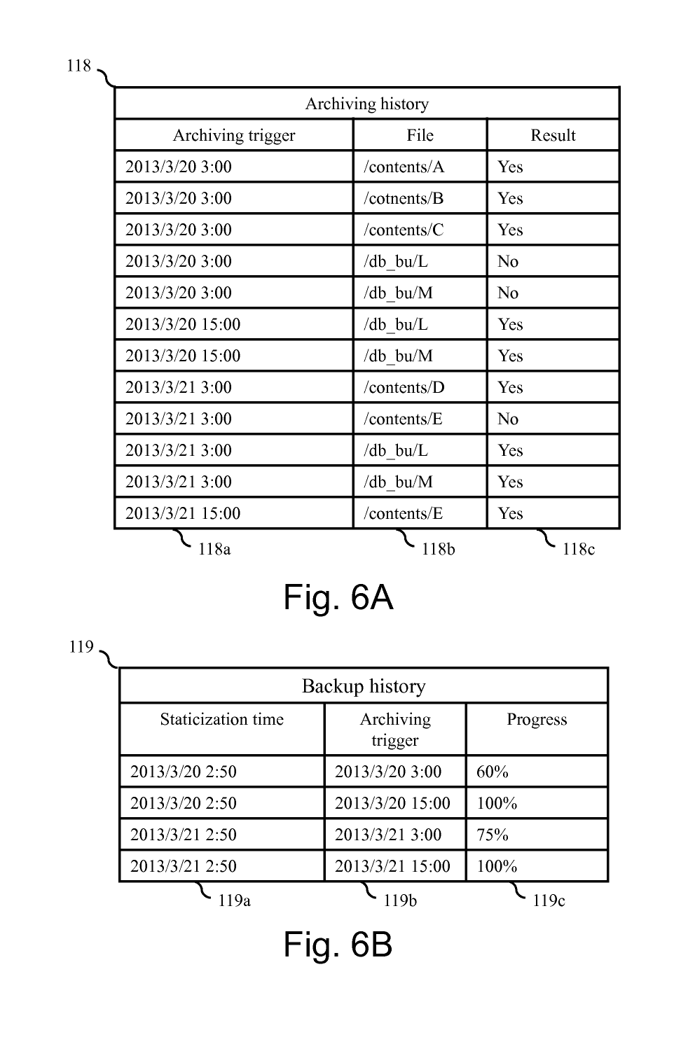

FIG. 6A is a configuration diagram of an example of archiving history according to the embodiment.

The archiving history 118 stores information representing an execution history of archiving processes. The archiving history 118 includes columns of an archiving trigger 118a, a file 118b, and a result 118c.

The archiving trigger 118a stores a time of a trigger of an archiving process (archiving trigger: archiving start time). The file 118b stores a path name of a file to be a target of an archiving process. The result 118c stores a result of an archiving process. In the result 118c, when archiving of the file whose path name is the entry in the file 118b has been performed (when the file has been transmitted to the archive file 2), “yes” is stored as a result, and when archiving has not been performed, “no” is stored as a result. FIG. 6B is a configuration diagram of an example of backup history according to the embodiment.

The backup history 119 stores information representing a progress of a backup process at each archiving trigger. The backup history 119 includes columns of a staticization time 119a, an archiving trigger 119b, and a progress 119c.

The staticization time 119a stores a time (staticization time) when the DB 113 is staticized (a DB file can be copied to the first FS 114 after the DB 113 is staticized). The archiving trigger 119b stores a time of an archiving trigger at which a DB file corresponding to the DB 113 having been staticized at the staticization time has been transmitted (or had been scheduled to be transmitted) to the archive storage 2 by the archiving function. The progress 119c stores a progress indicating a proportion of transmitted files among files necessary for consistent backup.

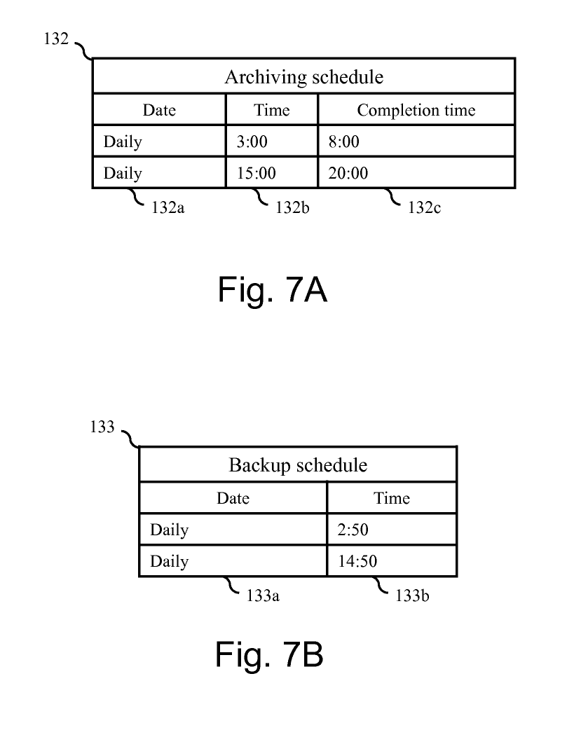

FIG. 7A is a configuration diagram of an example of an archiving schedule according to the embodiment.

The archiving schedule 132 stores a time when an archiving process is executed (archiving start time). The archiving schedule 132 includes columns of a date 132a, a time 132b, and a completion time 132c. The date 132a stores information related to a date on which an archiving process is executed. When archiving processes are to be executed every day, “daily” is set to the date 132a. The time 132b stores a time at which an archiving process is started. The completion time 132c stores a time (completion time) at which an archiving process is completed. When processing of all files that are archiving targets has not been finished by the completion time, the archiving process is suspended at that time point.

FIG. 7B is a configuration diagram of an example of a backup schedule according to the embodiment.

The backup schedule 133 stores a time when a backup process is executed (backup start time). The backup schedule 133 includes columns of a date 133a and a time 133b. The date 133a stores information related to a date on which a backup process is executed. When backup processes are to be executed every day, “daily” is set to the date 133a. The time 133b stores a time at which a backup process is started.

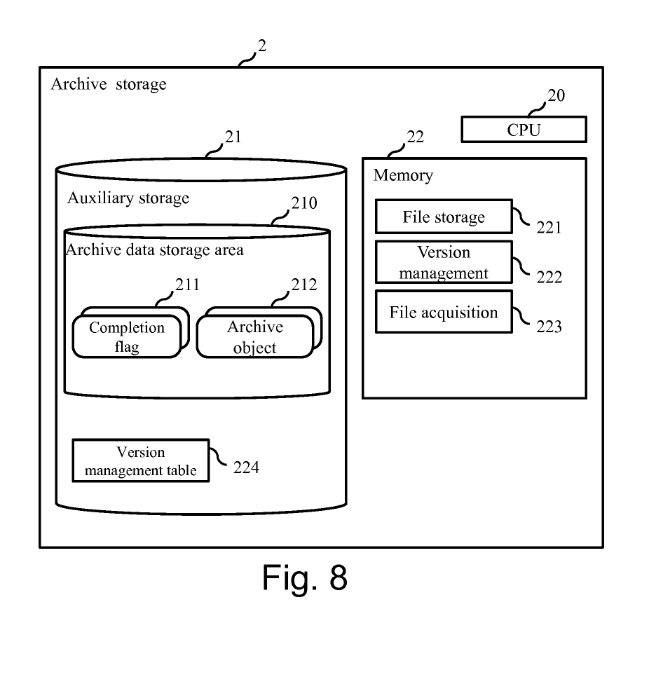

FIG. 8 is a configuration diagram of an archive storage according to the embodiment.

The archive storage 2 is a computer and includes a communication interface device (not shown), a storage device (for example, a memory 22 and an auxiliary storage 21), and a CPU 20 connected to these devices.

The communication interface device is an interface device for communicating with the file storage 1 (as well as the management terminal 5).

The CPU 20 executes various processes by executing a program stored in the memory 22. In FIG. 8, various functional units that are realized by the CPU 20 by executing a program stored in the memory 22 are displayed in the memory 22 for the sake of brevity. Specifically, a file storage unit 221, a version managing unit 222, and a file acquiring unit 223 are configured in the archive storage 2 by executing a program stored in the memory 22.

In response to a file storage request from the file storage 1, the file storage unit 221 stores a received file in the archive data storage area 210 as an object with a specified object ID. When the file storage unit 221 receives a data storage request specifying an object ID of an object already stored in the archive data storage area 210 from the file storage 1, the file storage unit 221 stores received data in the archive data storage area 210 as an object of a new version of the stored object without overwriting the stored object. Moreover, when data is stored as an object of a new version, the file storage unit 221 sends back a version number of the new version to the file storage 1 that is a request source. The version managing unit 222 determines a version number of an object that is stored in the archive data storage area 210. In the present embodiment, when the version managing unit 222 receives a file storage request specifying an object ID of an object already stored in the archive data storage area 210 from the file storage 1, the version managing unit 222 determines a new version number corresponding to the already-stored object. In the present embodiment, for example, a version number is expressed by an integer value and new data is to always have a larger number than old data. In response to a file acquisition request from the file storage 1, the file acquiring unit 223 acquires an object corresponding to the object ID and the version number specified in the file acquisition request from the archive data storage area 210 and sends back the object as a file to the file storage 1.

The memory 22 stores programs for configuring the respective functional units and various types of information. The auxiliary storage 21 is one or more nonvolatile storage devices such as one or more HDDs. The archive data storage area 210 based on the auxiliary storage 21 is provided in the file storage 1. The archive data storage area 210 stores completion flags 211 and archive objects (objects) 212. In addition, the auxiliary storage 21 stores aversion management table 224 that manages version information of the objects 212.

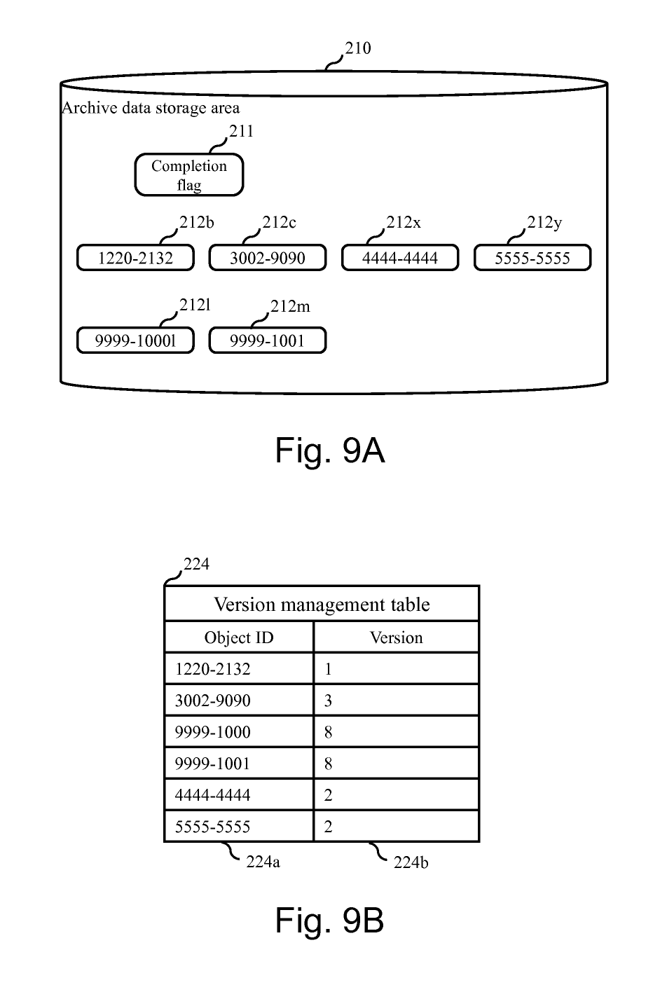

FIG. 9A is a configuration diagram of an archive data storage area according to the embodiment.

For every single archiving process, the archive data storage area 210 stores transmission target files and a completion flag 211 of the archiving process. The transmission target files stored in the archive data storage area 210 by an archiving process are objects 212 (for example, objects 212b, 212c, 212x, 212y, and the like) as referred to in the present embodiment.

FIG. 9B is a configuration diagram of an example of a version management table according to the embodiment.

The version management table 224 is a table for managing versions of the objects 212 and includes columns of an object ID 224a and a version 224b. The object ID 224a stores an ID (object ID: data ID) of an object stored in the archive data storage area 210. The version 224b stores a largest (newest) version number of an object corresponding to an object ID of an entry. The version management table 224 shown in FIG. 9B reveals that, since 8 is a largest version number of objects whose object IDs are 9999-1000, objects 212 of versions 1 to 8 are stored in the archive data storage area 210.

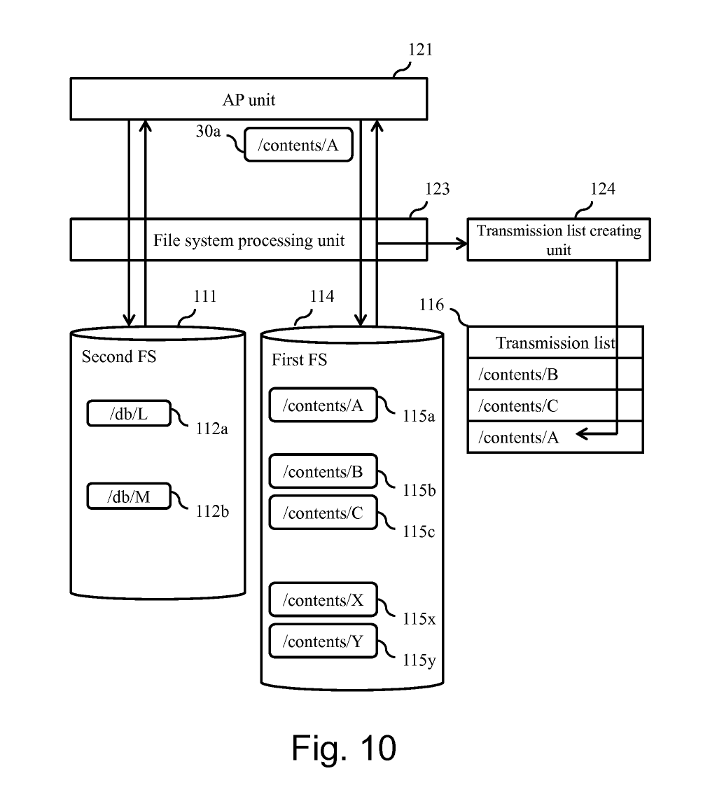

FIG. 10 is a diagram for explaining an outline of a transmission list creating process according to the embodiment.

When the file system processing unit 123 receives a file “/contents/A” from the AP unit 121, the file system processing unit 123 stores the file “/contents/A” in the first FS 114 and, at the same time, notifies the transmission list creating unit 124 of a path name “/contents/A” of the file. Upon receiving notification of the path name “/contents/A” of the file, the transmission list creating unit 124 adds the path name “/contents/A” of the file to the end of the transmission list 116. Accordingly, the path name of the file stored in the first FS 114 is to be stored in the transmission list 116. Moreover, the file system processing unit 123 also notifies the transmission list creating unit 124 of a path name of a file even when storing a database file of the backup processing unit 125 in the first FS 114.

In addition, the file system processing unit 123 receives an indication to record related information of the file “/contents/A” in the DB 113 from the AP unit 121 and changes contents of the files 112a and 112b that constitute the DB 113. At this point, the file system processing unit 123 does not notify the transmission list creating unit 124 of path names of files with respect to changes made to the files stored in the second FS 111.

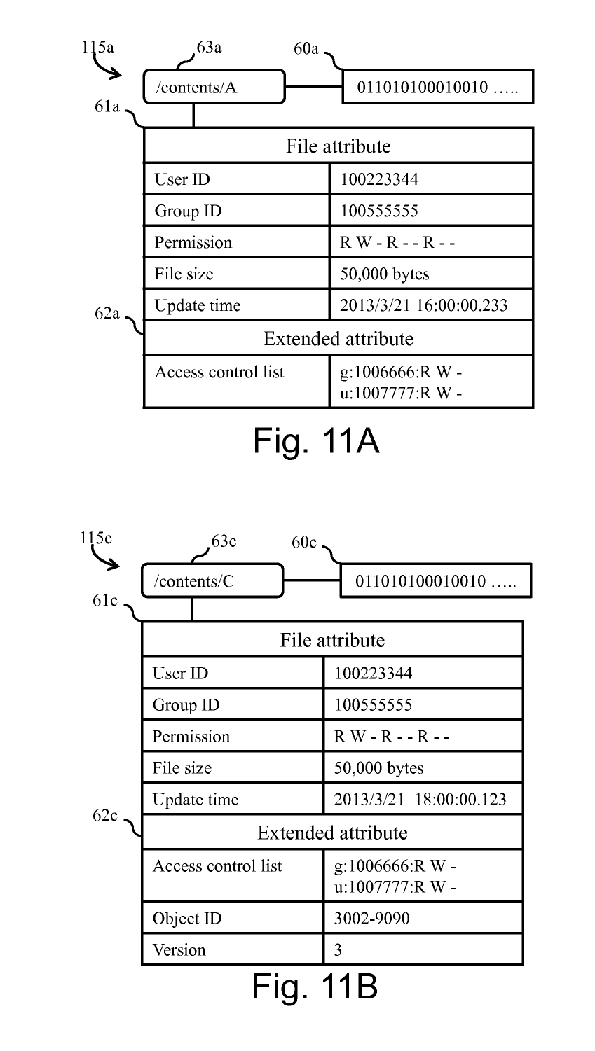

FIG. 11A is a configuration diagram of an example of a file according to the embodiment. For example, FIG. 11A represents a configuration example of a file 115a.

The file 115a includes a directory entry 63a, file data 60a, a file attribute 61a, and an extended attribute 62a. The directory entry 63a is information for identifying a file in an FS. Moreover, a path name may be used in place of the directory entry 63a. The file data 60a represents contents of a file. For example, in a case of an image file, the file data 60a is pixel data. The file attribute 61a includes information such as an owner of a file, an access right (permission), a file size, and an update time. The extended attribute 62a includes, for example, information on an attribute name and a value thereof set to a user and an access control list.

FIG. 11B is a configuration diagram of another example of a file according to the embodiment. For example, FIG. 11B represents a configuration example of a file 115c. It is assumed that the file 115c is a file that has been stored in the archive storage 2 in the past.

The file 115c includes a directory entry 63c, file data 60c, a file attribute 61c, and an extended attribute 62c. The directory entry 63c, the file data 60c, and the file attribute 61c are similar to the directory entry 63a, the file data 60a, and the file attribute 61a shown in FIG. 11A. The extended attribute 62c includes an object ID and a version number of an object when stored in the archive storage 2. The extended attribute 62c shown in FIG. 11B reveals that the object ID is 3002-9090 and the version number is 3. Moreover, since there is a possibility that the file data 60c is to be changed after an object corresponding to the file is stored in the archive storage 2, contents stored in the file data 60c do not necessary match contents of the object whose object ID is 3002-9090 and whose version number is 3 in the archive storage 2.

Next, an outline of operations of processes by a computer system according to the embodiment will be described.

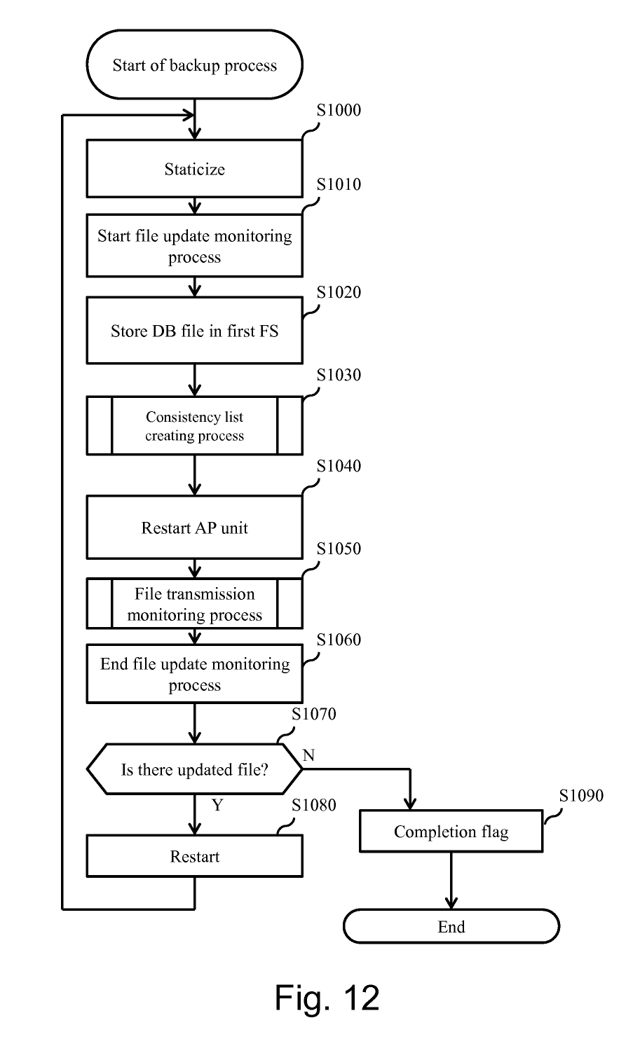

FIG. 12 is a flow chart of a backup process according to the embodiment.

A backup process is started when a backup start time set in the backup schedule 133 arrives.

First, the backup processing unit 125 staticizes the AP unit 121 (S1000). Specifically, the backup processing unit 125 requests the AP unit 121 to synchronize a state of the group of files 115 and a state of the DB 113 with each other and to temporarily suspend processing of requests from the client 3. Synchronization of the states of the group of files and the DB involves, with respect to each file in the group of files 115, writing out data to the group of DB files 112 constituting the DB 113 so that the file management database 14 is up to date. Accordingly, the AP unit 121 synchronizes states of the group of files and the DB and temporarily suspends addition and update of files.

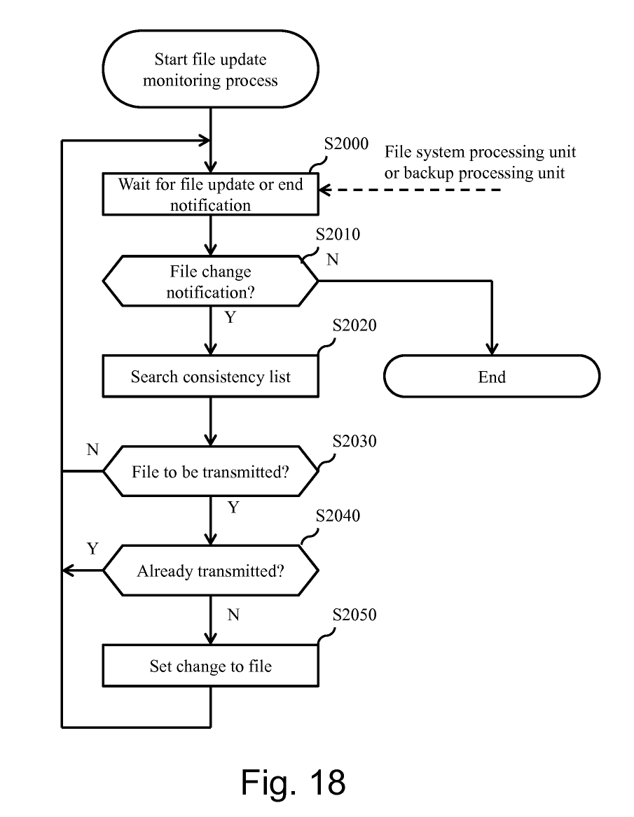

Next, the backup processing unit 125 starts up the update monitoring unit 128 and starts a monitoring process of updates of files (S1010). Accordingly, the update monitoring unit 128 executes a file update monitoring process (refer to FIG. 18) by a different process from a backup process. In the file update monitoring process, updates of files in the first FS 114 are monitored.

The backup processing unit 125 then copies DB files 112 in the second FS 111 to the first FS 114 (S1020).

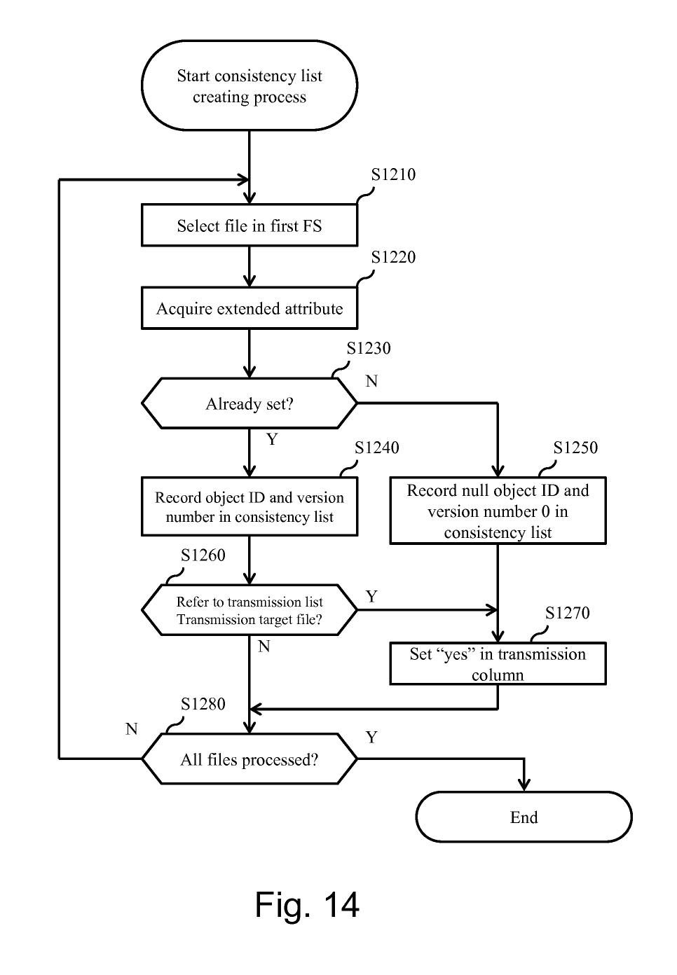

Next, the consistency list creating unit 126 executes a consistency list creating process (refer to FIG. 14) for creating a consistency list 117 (S1030).

Subsequently, the backup processing unit 125 restarts operation of the staticized AP unit 121 (S1040). Accordingly, the AP unit 121 resumes normal operation.

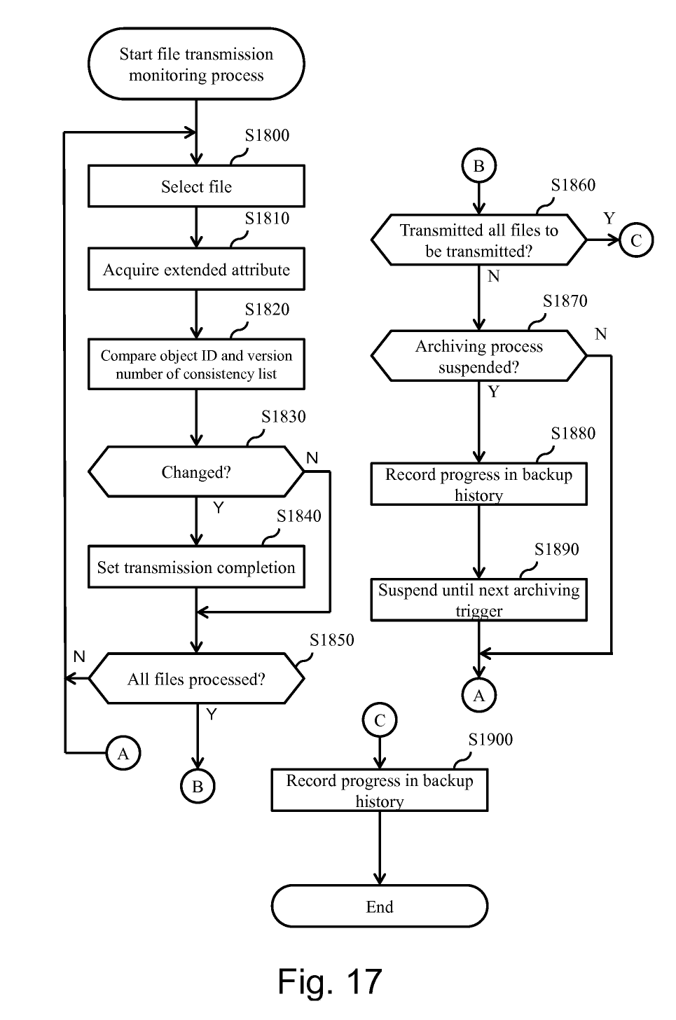

Next, the consistency monitoring unit 127 executes a file transmission monitoring process (refer to FIG. 17) for monitoring transmission of files to the archive storage 2 by the archive processing unit 122 (S1050). Subsequently, the backup processing unit 125 suspends the update monitoring unit 128 and ends the file update monitoring process (S1060).

Next, the backup processing unit 125 refers to the consistency list 117 and determines whether or not there is a file that has been updated before being transmitted among the files registered in the consistency list 117 (S1070). As a result, when there is a file that has been updated before being transmitted (S1070: Y), since consistency of files in the consistency list 117 cannot be secured, the backup processing unit 125 advances processing to step S1050 in order to restart from the process of staticizing the AP unit 121 (S1080). Accordingly, a group of files for which consistency can be secured can be appropriately backed up.

On the other hand, when there are no files that have been updated before being transmitted (S1070: N), the completion flag creating unit 129 refers to the consistency list 117 and creates a completion flag, transmits the completion flag to the archive storage 2, and causes the archive storage 2 to store the completion flag (S1090). Subsequently, the backup processing unit 125 ends the backup process. The completion flag will be described later. According to this process, the completion flag can be appropriately stored in the archive storage 2.

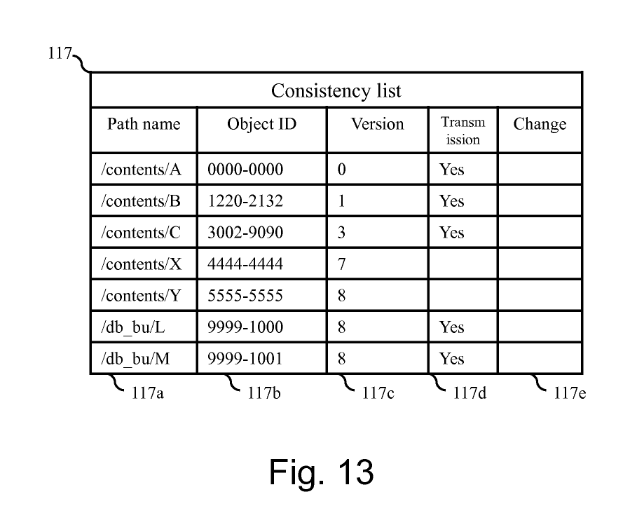

FIG. 13 is a configuration diagram of an example of a consistency list according to the embodiment.

The consistency list 117 includes columns of a path name 117a, an object ID 117b, a version 117c, a transmission 117d, and a change 117e. The path name 117a stores a path name of a file necessary to secure consistency. In the present embodiment, path names (/db_bu/L and /db_bu/M) of copied files of the DB files 112 created in the first FS 114 are also included. If a file corresponding to an entry has been archived in the archive storage 2 in the past, the object ID 117b stores an object ID set at that time. Meanwhile, when archiving has never been performed to the archive storage 2, the object ID 117b stores a prescribed value expressing null (for example, 0000-0000). The version 117c stores a version number used when archived in the past. When archiving has not been performed in the past, 0 is set to the version 117c. The transmission 117d stores information indicating whether or not a file corresponding to an entry is a file that needs to be transmitted for archiving or, in other words, whether or not the file has been updated or added after a previous archiving process. In a case where the file needs to be transmitted for archiving, “yes” is set to the transmission 117d. In addition, when a file corresponding to the entry has been transmitted, “transmitted” is set to the transmission 117d. Information indicating whether or not a file corresponding to an entry has been updated before being transmitted is set to the change 117e. When the file has been updated before being transmitted, “yes” is set to the change 117e.

FIG. 14 is a flow chart of a consistency list creating process according to the embodiment.

The consistency list creating process corresponds to the process of step S1030 in FIG. 12.

The consistency list creating unit 126 selects one of the files stored in the first FS 114 as a processing target file (S1210). Next, the consistency list creating unit 126 acquires an extended attribute of the file selected from the first FS 114 (S1220). The consistency list creating unit 126 then determines whether or not an object ID and a version number have already been set in the acquired extended attribute (S1230).

As a result, when an object ID and a version number are set in the acquired extended attribute (S1230: Y), the consistency list creating unit 126 adds an entry of the processing target file to the consistency list 117, sets the object ID set in the extended attribute to the object ID 117b of the entry, sets the version number in the extended attribute to the version 117c of the entry, and advances the process to step S1260 (S1240).

In step S1260, the consistency list creating unit 126 refers to the transmission list 116 and determines whether or not the selected file is a transmission target file. As a result, when the selected file is the transmission target file (S1260: Y), the consistency list creating unit 126 advances the process to step S1270, and when the selected file is not the transmission target file (S1260: N), the consistency list creating unit 126 advances the process to step S1280.

On the other hand, when an object ID and a version number are not set in the extended attribute (S1230: N), the consistency list creating unit 126 adds an entry of the processing target file to the consistency list 117, sets an object ID (0000-0000) representing null to the object ID 117b of the entry, sets a version number of 0 to the version 117c of the entry, and advances the process to step S1270 (S1250).

In step S1270, the consistency list creating unit 126 sets “yes” to the transmission 117d of the entry of the processing target file in the consistency list 117 and advances the process to step S1280.

In step S1280, the consistency list creating unit 126 determines whether or not processing has been performed on all files in the first FS 114 as processing targets, and when processing has not been performed on all files as processing targets (S1280: N), the consistency list creating unit 126 advances the process to step S1210. On the other hand, when processing has been performed on all files as processing targets (S1280: Y), the consistency list creating unit 126 ends the consistency list creating process. According to the consistency list creating process, a list of files necessary for securing consistency can be appropriately created.

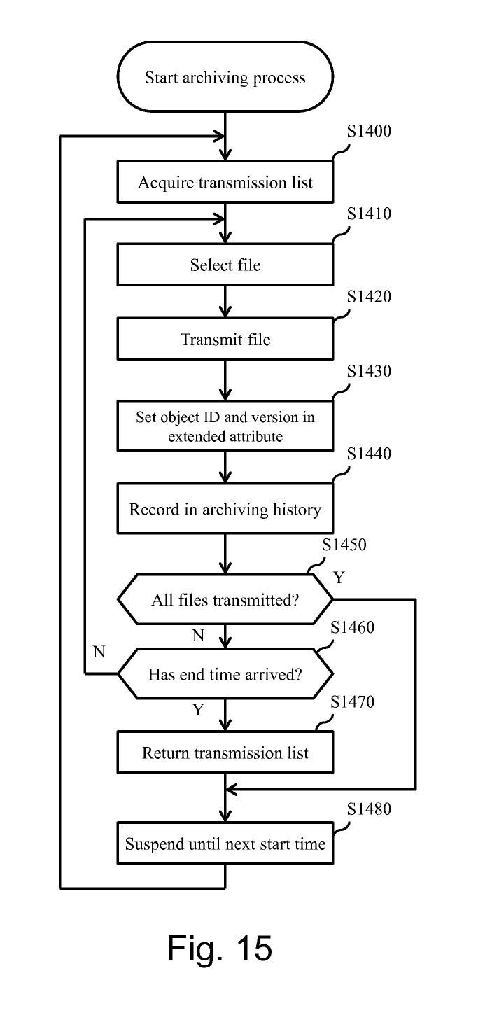

FIG. 15 is a flow chart of an archiving process according to the embodiment.

The archiving process is a process that is executed independently of the backup process and is started when a time (archiving trigger) set in the archiving schedule 132 arrives. The archiving process is executed by a different process from the backup process.

The archive processing unit 122 acquires the transmission list 116 from the auxiliary storage 11, loads the transmission list 116 onto the memory 12, and empties the transmission list 116 in the auxiliary storage 11 (S1400). Due to a process such as that shown in FIG. 10, a file to be transmitted in a next archiving process is added to the transmission list 116.

Next, the archive processing unit 122 selects one processing target file from the transmission list 116 loaded to the memory 12 (S1410). The archive processing unit 122 then transmits the selected file and an object ID to be associated with the file to the archive storage 2 (S1420). At this point, when the file is a file that has been transmitted to the archive storage 2 in the past, the archive processing unit 122 transmits the object ID acquired from the extended attribute of the file, and when the file is not a file that has been transmitted in the past, the archive processing unit 122 generates and transmits an object ID. The object ID generated at this point may have a random value. Subsequently, a version number of an object corresponding to the transmitted file is to be sent back as a response from the archive storage 2.

Next, the archive processing unit 122 sets the version number sent back as a response to the extended attribute of the selected file (S1430). Moreover, when an object ID is newly generated, the generated object ID is also set to the extended attribute of the file.

Next, the archive processing unit 122 adds an entry to the archiving history 118 and sets an archiving trigger and information of a transmitted file to the added entry (S1440). The archive processing unit 122 then determines whether or not all files of the transmission list 116 loaded onto the memory 12 has been transmitted to the archive storage 2 (S1450). As a result, when all of the files of the transmission list 116 have been transmitted (S1450: Y), the archive processing unit 122 advances the process to step S1480.

On the other hand, when all of the files of the transmission list 116 have not been transmitted (S1450: N), the archive processing unit 122 determines whether or not a completion time set in the archiving schedule 132 has arrived (S1460).

As a result, when the completion time has not arrived (S1460: N), the archive processing unit 122 advances the process to step S1410 and continues processing on a next processing target file.

On the other hand, when the completion time has arrived (S1460: Y), the archive processing unit 122 adds a file path name of a file not yet transmitted among the files in the transmission list 116 loaded to the memory 12 to the transmission list 116 of the auxiliary storage 12 (in other words, the transmission list 116 for a next archiving process) and, at the same time, adds an entry to the archiving history 118 and sets information on the file to the added entry (S1470). Accordingly, a file which is registered in the transmission list 116 and which has not been transmitted to the archive storage 2 is to be appropriately transmitted by a process at a next or subsequent archiving trigger.

In step S1480, the archive processing unit 122 suspends processing until a start time of a next archiving process or, in other words, a time of a next archiving trigger set in the archiving schedule 132 arrives, and starts an archiving process when the start time arrives.

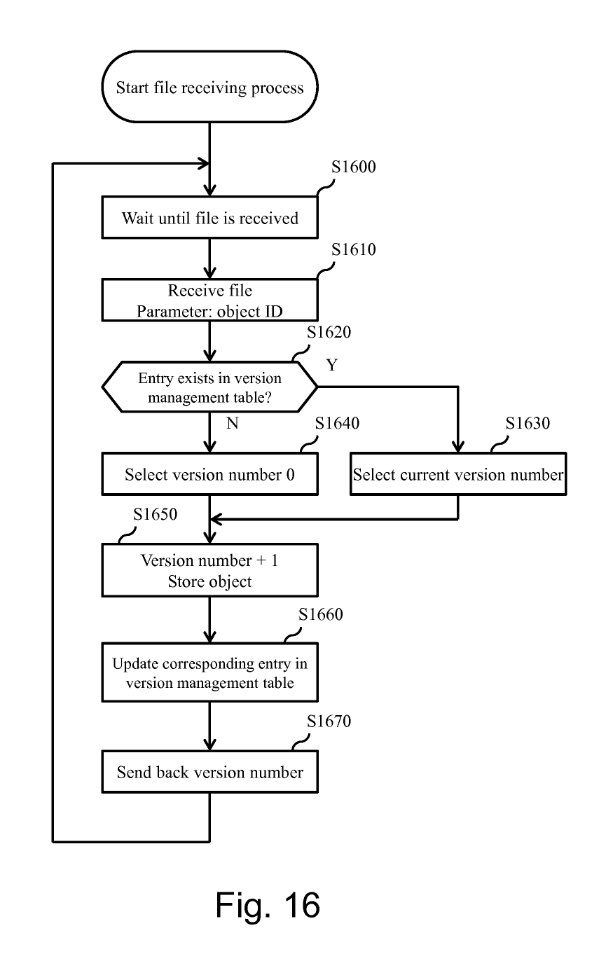

FIG. 16 is a flow chart of a file receiving process according to the embodiment.

The file receiving process is a process executed by the file storage unit 221 of the archive storage 2. Execution of the file receiving process is started when, for example, the archive storage 2 is started up.

The file storage unit 221 waits until a file storage request is received from the file storage 1 (S1600). Next, upon receiving the file storage request, the file storage unit 221 receives a file corresponding to the file storage request from the file storage 1 (S1610). In this case, the file storage request includes an object ID of an object corresponding to the file that is a storage target.

Next, the file storage unit 221 determines whether or not an entry corresponding to the received object ID is included in the version management table 224 (S1620).

As a result, when an entry corresponding to the object ID is included in the version management table 224 (S1620: Y), the file storage unit 221 selects a current version number set to the entry and loads the version number to the memory 22 (S1630), and advances the process to step S1650.

On the other hand, when an entry corresponding to the object ID is not included in the version management table 224 (S1620: N), the file storage unit 221 loads a version number of 0 to the memory 22 (S1640), and advances the process to step S1650.

In step S1650, the file storage unit 221 adds 1 to the version number loaded to the memory 22 and stores the received file in the archive data storage area 210 as an object which corresponds to the specified object ID and whose version is the version number after the addition.

Next, the file storage unit 221 stores the version number on the memory 22 as a version number of an entry corresponding to the object ID of the version management table 224 (S1660), sends back the version number as a response to the file storage request to the file storage 1 (S1670), and advances the process to step S1600. Accordingly, the file storage 1 can be appropriately notified of a version number of an object corresponding to the file.

FIG. 17 is a flow chart of a file transmission monitoring process according to the embodiment.

The file transmission monitoring process is a process corresponding to step S1050 in FIG. 12.

The consistency monitoring unit 127 selects a file from the files registered in the consistency list 117 (S1800) and acquires an extended attribute of the selected file from the first FS 114 (S1810).

Next, the consistency monitoring unit 127 compares an object ID and a version number set in the extended attribute with an object ID and aversion number set in the consistency list 117 (S1820).

As a result, when the object ID and the version number set in the consistency list 117 differ from the object ID and the version number set in the extended attribute (S1830: Y), since this means that the file has been transmitted, the consistency monitoring unit 127 sets “transmitted” to the transmission 117d of the entry in the consistency list 117, sets the object ID and the version number set in the extended attribute to the object ID 117b and the version 117c (step S1840), and advances the process to step S1850. Accordingly, since an object ID and a version number corresponding to the file stored in the archive storage 2 are to be registered in the consistency list 117, an object corresponding to a file in the archive storage 2 can be appropriately specified. On the other hand, when the object ID and the version number set in the consistency list 117 do not differ from the object ID and the version number set in the extended attribute (S1830: N), the consistency monitoring unit 127 advances the process to step S1850.

In step S1850, the consistency monitoring unit 127 determines whether or not processing has been performed on all files in the consistency list 117, and when processing has not been performed on all of the files (S1850: N), the consistency monitoring unit 127 advances the process to step S1800. On the other hand, when processing has been performed on all of the files (S1850: Y), the consistency monitoring unit 127 advances the process to step S1860.

In step S1860, the consistency monitoring unit 127 determines whether or not all transmission target files in the consistency list 117 have been transmitted. At this point, whether or not all transmission target files have been transmitted can be determined based on whether or not “transmitted” is set to the transmission 117d of all files for which “yes” has been set to the transmission 117d in the consistency list 117. As a result, when all transmission target files have been transmitted (S1860: Y), the consistency monitoring unit 127 sets 100% to the progress 119c of an entry corresponding to the current archiving trigger in the backup history 119 (S1900) and ends the file transmission monitoring process.

On the other hand, when all transmission target files have not been transmitted (S1860: N), the consistency monitoring unit 127 determines whether or not the archiving process has been suspended or, in other words, whether or not the archiving process has been advanced to and is suspended at step S1480 shown in FIG. 15 (S1870).

As a result, when the archiving process has not been suspended (S1870: N), the consistency monitoring unit 127 advances the process to step S1800.

On the other hand, when the archiving process has been suspended (S1870: Y), the consistency monitoring unit 127 sets a current progress to the progress 119c of the entry corresponding to the current archiving trigger in the backup history 119 (S1880). In this case, as the current progress, for example, a ratio of files for which the transmission 117d is set to “transmitted” with respect to a total number of files for which “yes” or “transmitted” is set to the transmission 117d in the consistency list 117 is adopted.

Next, the consistency monitoring unit 127 suspends the process until a next archiving trigger arrives, and starts a file transmission monitoring process when the next archiving trigger arrives (S1890).

According to this process, whether or not all of the transmission target files set in the consistency list 117 have been transmitted to the archive storage 2 can be appropriately monitored.

FIG. 18 is a flow chart of a file update monitoring process according to the embodiment.

The file update monitoring process is a process started in step S1010 shown in FIG. 12. The file update monitoring process is executed by a different process from the backup process.

The update monitoring unit 128 waits for a file update notification from the file system processing unit 123 or an end notification of a backup process from the backup processing unit 125 (S2000). In this case, a file update notification from the file system processing unit 123 includes a path name of a file for which an update has occurred.

Next, the update monitoring unit 128 determines whether or not the received notification is a file update notification (S2010). As a result, when the received notification is not a file update notification or, in other words, when the received notification is an end notification of a backup process (S2010: N), the update monitoring unit 128 ends the file update monitoring process.

On the other hand, in the case of a file update notification (S2010: Y), the update monitoring unit 128 searches in the consistency list 117 and determines whether a path name of a notified file (referred to as a target file in the description of the process in FIG. 18) is registered in the consistency list 117 (S2020).

Next, the update monitoring unit 128 determines whether or not the path name of the target file is registered in the consistency list 117 and, at the same time, whether or not the target file is a transmission target file (S2030). At this point, whether or not the target file is a transmission target file can be determined based on whether or not the transmission 117d of an entry corresponding to the target file in the consistency list 117 is “yes” or “transmitted”.

As a result, when the path name of the target file is not registered in the consistency list 117 or when the target file is not a transmission target file (S2030: N), the update monitoring unit 128 advances the process to step S2000.

On the other hand, as a result, when the path name of the target file is registered in the consistency list 117 and, at the same time, the target file is a transmission target file (S2030: Y), the update monitoring unit 128 determines whether or not the target file has already been transmitted to the archive storage 2 (S2040). At this point, whether or not the target file has already been transmitted can be determined based on whether or not the transmission 117d of an entry corresponding to the target file in the consistency list 117 is “transmitted”.

As a result, when the target file has already been transmitted (S2040: Y), the update monitoring unit 128 advances the process to step S2000. On the other hand, when the target file has not been transmitted (S2040: N), the update monitoring unit 128 sets “yes” to the change 117e of an entry corresponding to the target file in the consistency list 117 (S2050), and advances the process to step S2000.

According to the file update monitoring process, a file updated by the AP unit 121 before being transmitted to the archive storage 2 can be appropriately detected.

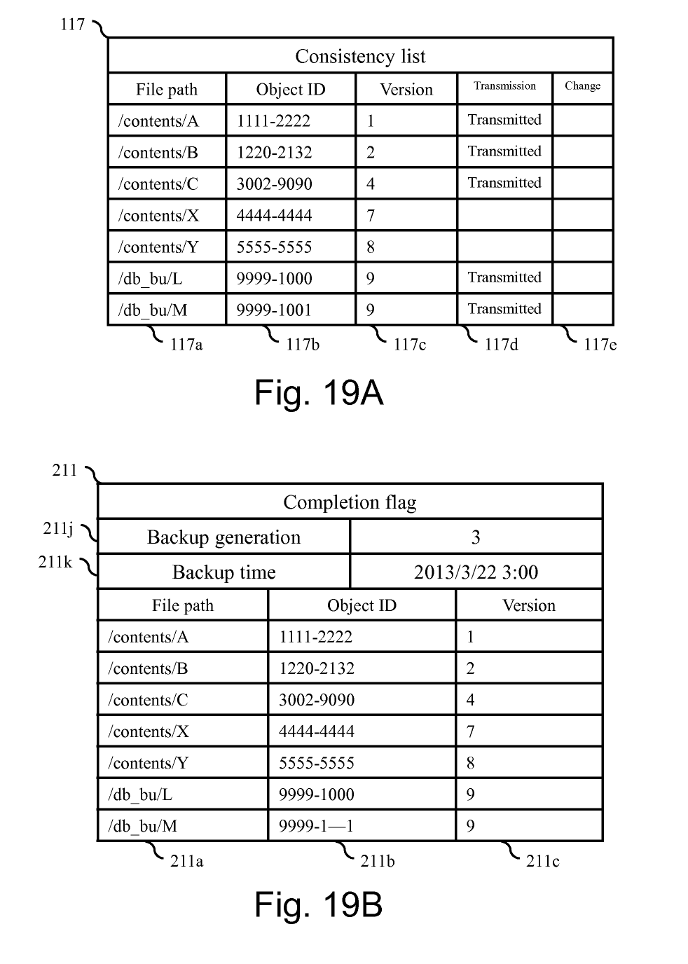

FIG. 19A is a configuration diagram of an example of a consistency list after a backup process is ended according to the embodiment. The consistency list 117 shown in FIG. 19A represents an example of a state after the end of a backup process of the consistency list 117 that had previously been in the state shown in FIG. 13.

After a backup process ends, with respect to an entry corresponding to a file expressed by /contents/A for which an initial value had been set as an object ID in the state shown in FIG. 13, an object ID set upon storing in the archive storage 2 is set to the object ID 117b, 1 is set as a version number to the version 117c, and “transmitted” is set to the transmission 117d.

In addition, with respect to entries for which object IDs were already not initial values and for which “yes” has been set to the transmission 117d or, in other words, entries of files /contents/B, /contents/C, /db_bu/L, and /db_bu/M in the state shown in FIG. 13, “transmitted” is set to the transmission 117d and new version numbers are set to the version 117c.

According to the consistency list 117, an object ID and a version number of an object in the archive storage 2 which corresponds to a file corresponding to a path name can be appropriately identified.

FIG. 19B is a configuration diagram of an example of a completion flag according to the embodiment. The completion flag shown in FIG. 19B represents an example of a completion flag created by referring to the consistency list 117 shown in FIG. 19A in step S1090 in FIG. 12.

The completion flag 211 includes fields of a backup generation 211j and a backup time 122k and columns of a file path 211a, an object ID 211b, and a version 211c.

The backup generation 211j stores a generation number representing a generation of backup. A time (backup time) when a backup process has been performed is set to the backup time 211k.

Contents of the columns with the same names in the consistency list 117 after the end of a backup process are set without modification in the respective columns of the file path 211a, the object ID 211b, and the version 211c. According to the completion flag 211, a file path name of each file in a group of files for which consistency is maintained and an object ID and a version number of an object corresponding to the file are managed. Therefore, by referring to the completion flag 211, a group of files for which consistency is maintained can be specified from the archive storage 2 and appropriately restored.

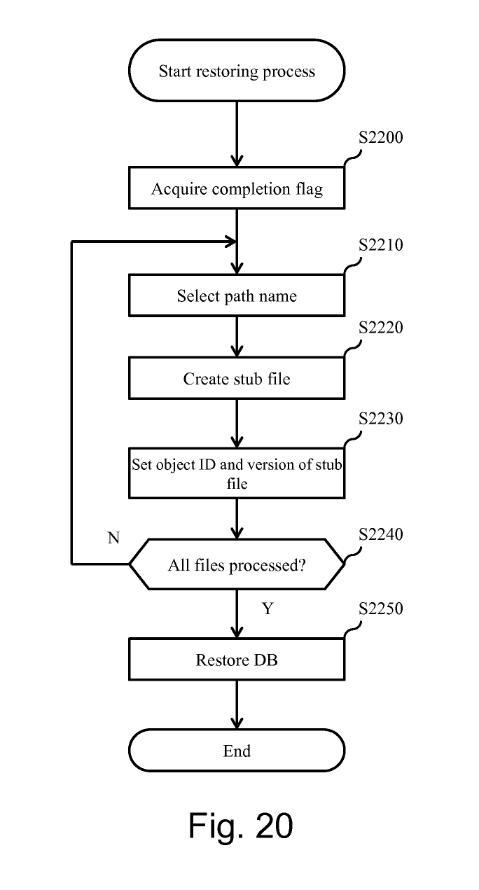

FIG. 20 is a flow chart of a restoring process according to the embodiment.

The restoring process is a process that is executed in a case where a failure or the like occurs in the file storage 1 and data is lost in order to restore the file storage 1 to a state of a prescribed backup time point and is executed when, for example, the file storage 1 receives a restore request from a user.

The restore processing unit 130 of the file storage 1 acquires the completion flag 211 corresponding to a backup time point to which restoration is to be performed from the archive storage 2 (S2200) and selects one file path name from file path names set in the completion flag 211 as a processing target (S2210).

Next, the restore processing unit 130 creates a stub file corresponding to the path name in the first FS 114 (S2200). In this case, a stub file refers to a file without any file data.

Next, the restore processing unit 130 sets an object ID and a version number set in the completion flag 211 to an extended attribute of the created stub file (S2230). Moreover, when the stub file is accessed by the AP unit 121, the file system processing unit 123 uses the object ID and the version number of the stub file to acquire data of a corresponding object from the archive storage 2, replaces a file of the data with the stub file, and executes a process corresponding to the access from the AP unit 121. Therefore, the AP unit 121 can appropriately access a necessary file.

Subsequently, the restore processing unit 130 determines whether or not processing has been performed on all files of the completion flag 211 (S2240), and when processing has not been performed on all files (S2240: N), the restore processing unit 130 advances the process to S2210.

On the other hand, when processing has been performed on all files (S2240: Y), the restore processing unit 130 reads out data (a file as an entity of a stub file) by performing a read access to a DB file that is restored as a stub file and copies the read data to the second FS 111 (S2250), and ends the restoring process. Due to the read access, the file system processing unit 123 acquires data from the archive storage 2 in a similar manner described above. At this point, path names of the respective files to be copied to the second FS 111 are not the path names (/db_bu/L, /db_bu/M) in the first FS 114 created in S1020 (refer to FIG. 12) but the original path names (/db/L, /db/M) in the second FS 111. Alternatively, a stub file may be copied to the second FS 111, and when an access is made to the copied stub file, data may be acquired from the archive storage 2 in a similar manner described above. Due to the restoring process, files of the file storage 1 and a DB can be appropriately restored to a state where consistency is secured.

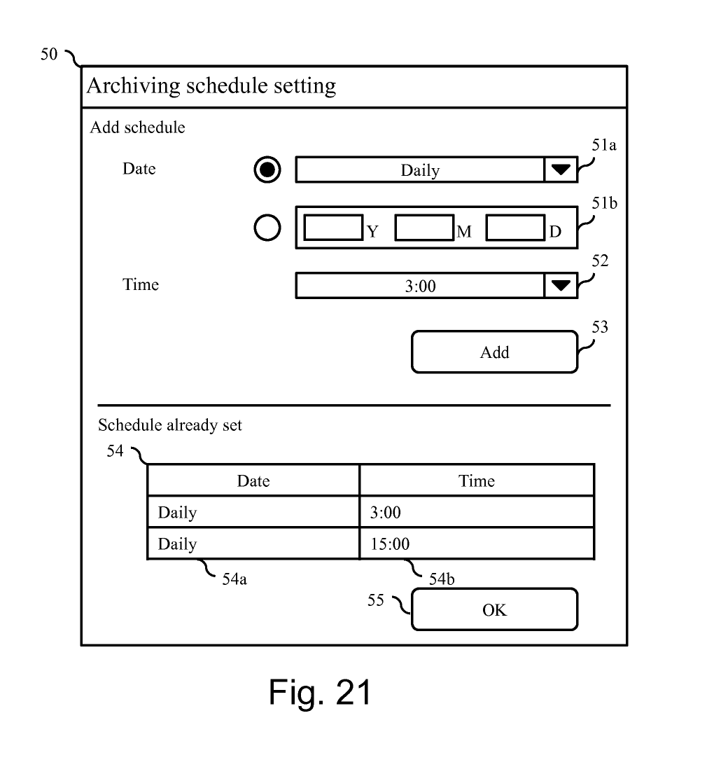

FIG. 21 is a configuration diagram of an archive schedule setting screen according to the embodiment.

An archive schedule setting screen 50 is a screen for setting a schedule of archiving processes and is displayed by the managing unit 131 of the file storage 1 on a prescribed display apparatus (for example, a display apparatus of the client 3) when, for example, the managing unit 131 accepts an indication to set a schedule of archiving processes from the user (from the client 3 of the user).

The archive schedule setting screen 50 includes date setting areas 51a and 51b for selecting or specifying a date of a schedule to be added, a time setting area 52 for selecting a time, an addition button 53 for accepting an addition indication, a display area 54 for displaying a schedule that is already set, and an OK button 55.

The date setting area 51a is an area for selecting an option (for example, daily, every other day, and Mondays) for specifying a date on which an archiving process is to be executed. The date setting area 51b is an area for accepting a specification of a particular date as a date on which an archiving process is to be executed. The time setting area 52 is an area for selecting a time at which an archiving process is to be executed. When the addition button 53 is pressed, the managing unit 131 adds a schedule with contents set in the date setting area 51a or the date setting area 51b and the time setting area 52 to the archiving schedule 132. Moreover, while a time after a lapse of a prescribed period of time from a start time is to be set as the completion time 132c of the archiving schedule 132 in the present embodiment, alternatively, specification of a specific time may be accepted from a user.

Information on a schedule already set in the archiving schedule 132 is displayed by the managing unit 131 in the display area 54. Columns of a date 54a and a time 54b are displayed in the display area 54.

When the OK button 55 is pressed, setting of a schedule using the archive schedule setting screen 50 is ended and the archive schedule setting screen 50 is closed.

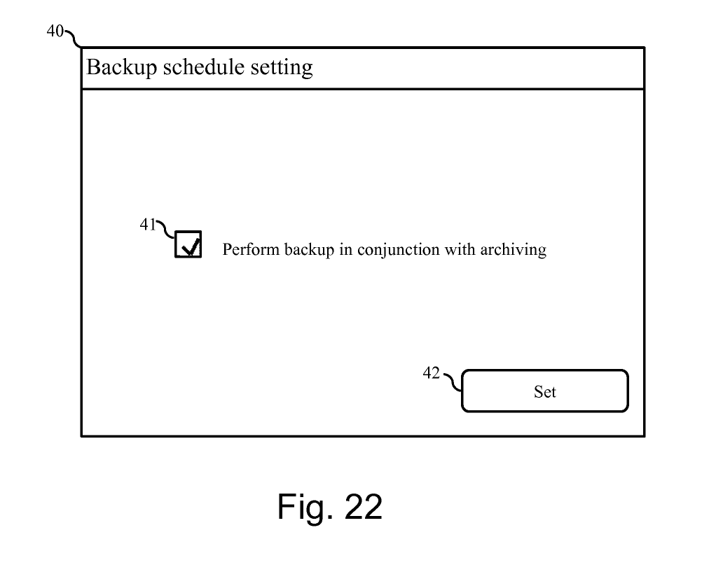

FIG. 22 is a configuration diagram of a backup schedule setting screen according to the embodiment.

A backup schedule setting screen 40 is a screen for setting whether or not a backup process is to be executed in conjunction with a schedule of archiving processes and is displayed by the managing unit 131 of the file storage 1 on a prescribed display apparatus (for example, a display apparatus of the client 3).

The backup schedule setting screen 40 includes a conjunction selection check box 41 for specifying whether or not a backup process in conjunction with an archiving process is to be executed and a setting button 42.

By switching on (by selecting) the conjunction selection check box 41, a setting of executing a backup process in conjunction with an archiving process can be performed in an easy and appropriate manner. When the setting button 42 is pressed when the conjunction selection check box 41 is switched on, the managing unit 131 creates a schedule of backup processes so that a backup process is executed at a prescribed period of time (for example, 10 minutes) prior to an execution start time of an archiving process and registers the created schedule to the backup schedule 133. For example, in the case of the archiving schedule 132 shown in FIG. 7A, the backup schedule 133 shown in FIG. 7B is to be created and a backup process is to be started 10 minutes before the execution of an archiving process.

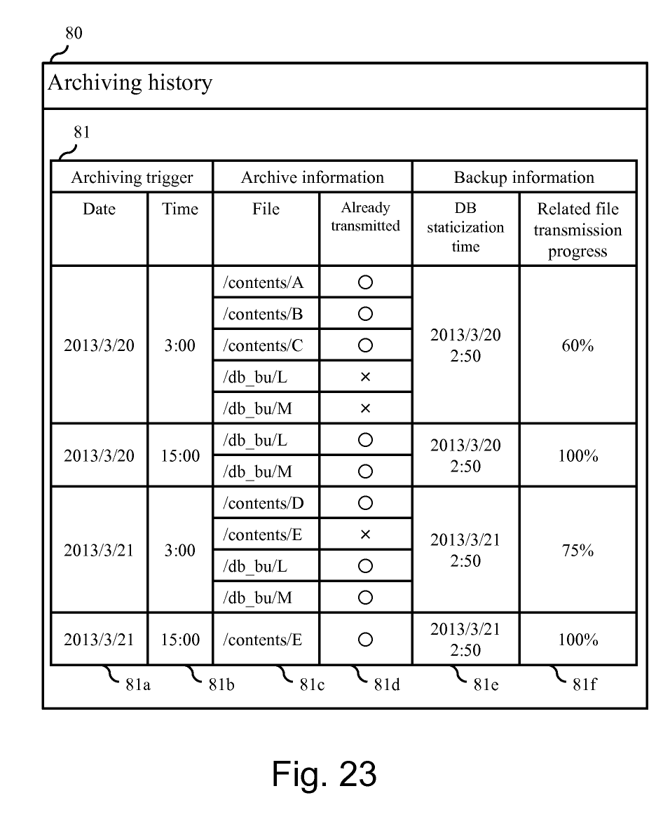

FIG. 23 is a configuration diagram of an archiving history display screen according to the embodiment.

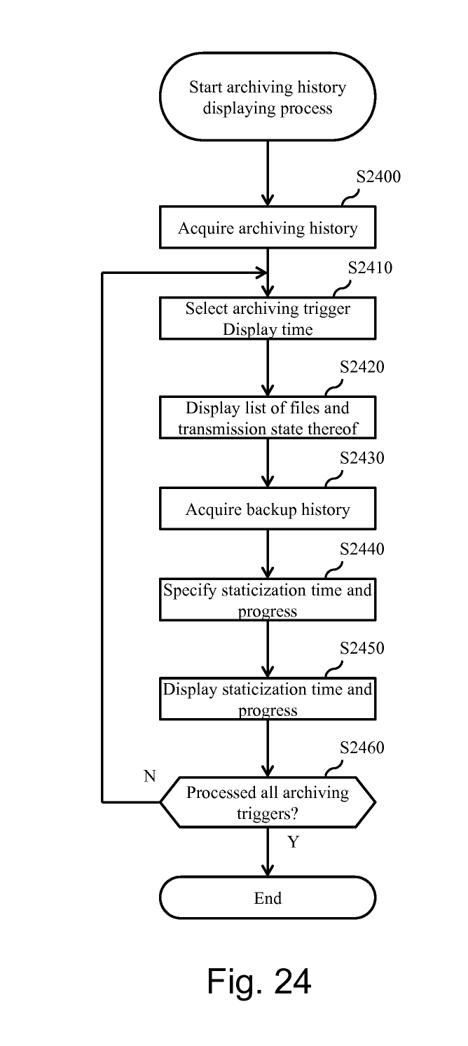

An archiving history display screen 80 is a screen for collectively confirming an execution result of an archiving process and an execution result of a backup process and is displayed by, for example, the managing unit 131 of the file storage 1 when an indication to display archiving history is accepted from an administrator (the management terminal 5 of the administrator) by executing archiving history display processing (refer to FIG. 24) on a prescribed display apparatus (for example, a display apparatus of the management terminal 5).

The archiving history display screen 80 includes a history display area 81. The history display area 81 includes columns of an archiving trigger date 81a, an archiving trigger time 81b, a file 81c, already transmitted 81d, a DB staticization time 81e, and related file transmission progress 81f.

The archiving trigger date 81a displays a date of an archiving trigger on which an archiving process has been executed. The archiving trigger time 81b displays a time of an archiving trigger at which an archiving process has been executed. The file 81c displays a path name of a file. Already transmitted 81d displays whether or not the file has been transmitted at the archiving trigger. The DB staticization time 81e displays a staticization time when a DB corresponding to a transmission target DB file at the archiving trigger. The related file transmission progress 81f displays a proportion of transmitted files among the transmission target files registered in the consistency list 117.

FIG. 24 is a flow chart of an archiving history displaying process according to the embodiment.

The archiving history displaying process is executed when, for example, the managing unit 131 of the file storage 1 accepts an indication to display archiving history from an administrator (the management terminal 5 of the administrator).

When the managing unit 131 of the file storage 1 accepts an indication to display archiving history from the management terminal 5 of the administrator, the managing unit 131 acquires the archiving history 118 (S2400).

Next, the managing unit 131 selects one archiving trigger from the plurality of archiving triggers in the archiving history 118 as a processing target and displays a date and a time of the archiving trigger in the archiving trigger date 81a and the archiving trigger time 81b on the archiving history display screen 80 (S2410).

Next, the managing unit 131 displays a path name and a result of a file which corresponds to the archiving trigger and which is registered in the archiving history 118 in the file 81c and already transmitted 81d on the archiving history display screen 80 (S2420).

The managing unit 131 then acquires the backup history 119 (S2430), executes a search on the backup history 119 using the archiving trigger as a key, and specifies a staticization time and a progress corresponding to the archiving trigger (S2440).

Next, the managing unit 131 displays the specified staticization time and progress in the DB staticization time 81e and the related file transmission progress 81f on the archiving history display screen 80 (S2450).

Subsequently, the managing unit 131 determines whether or not processing has been performed on all archiving triggers in the archiving history 118 as targets (S2460). When processing has not been performed on all archiving triggers as targets (S2460: N), the managing unit 131 advances the process to step S2410, and when processing has been performed on all archiving triggers as targets (S2460: Y), the managing unit 131 ends the archiving history displaying process.

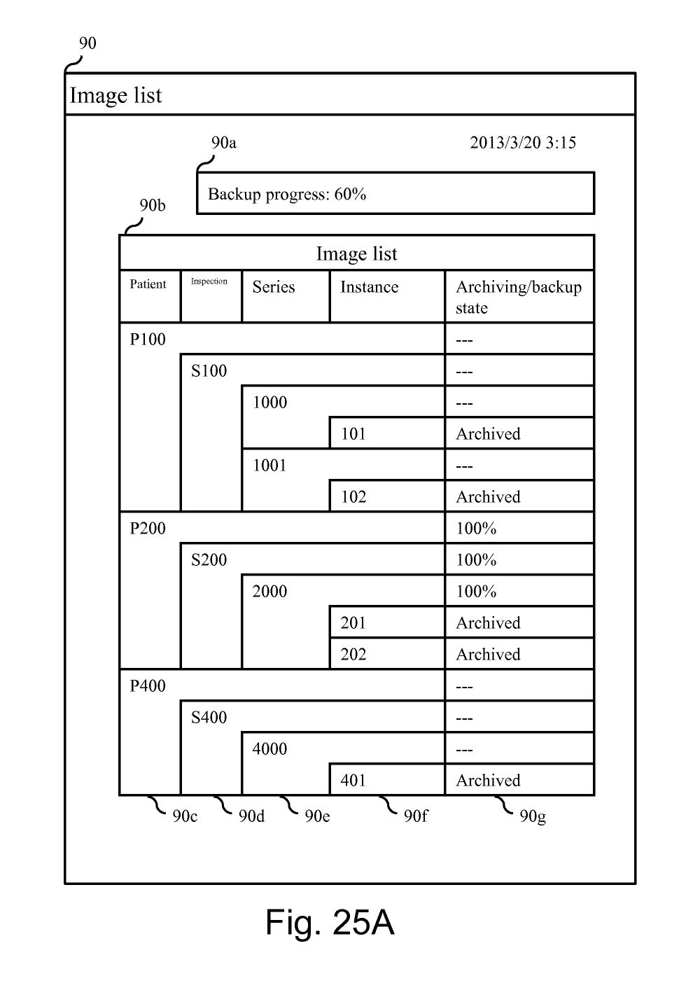

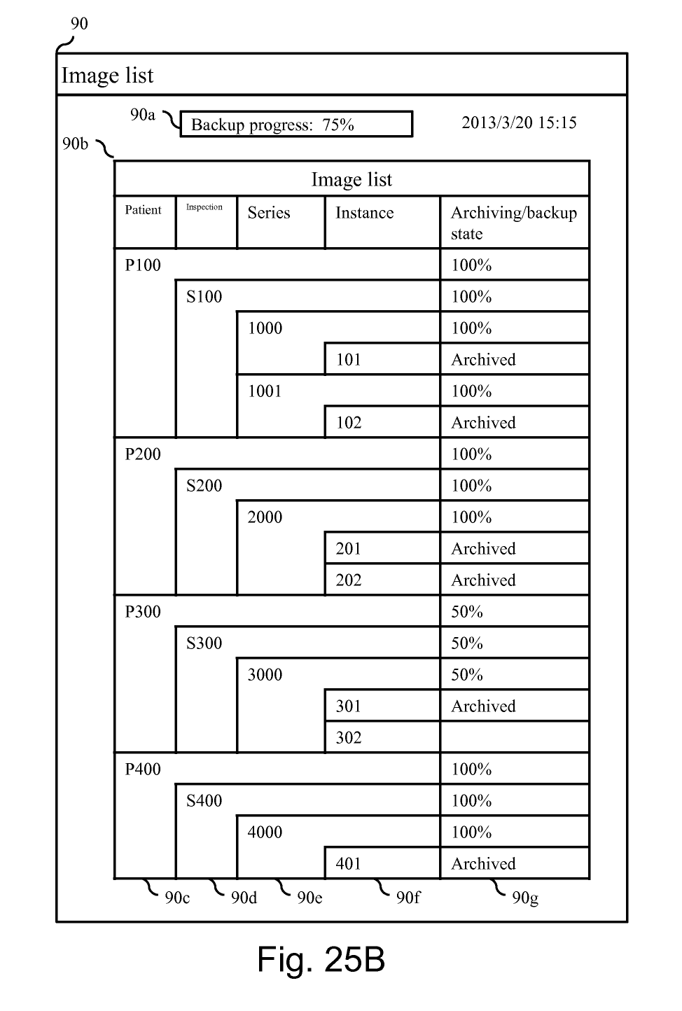

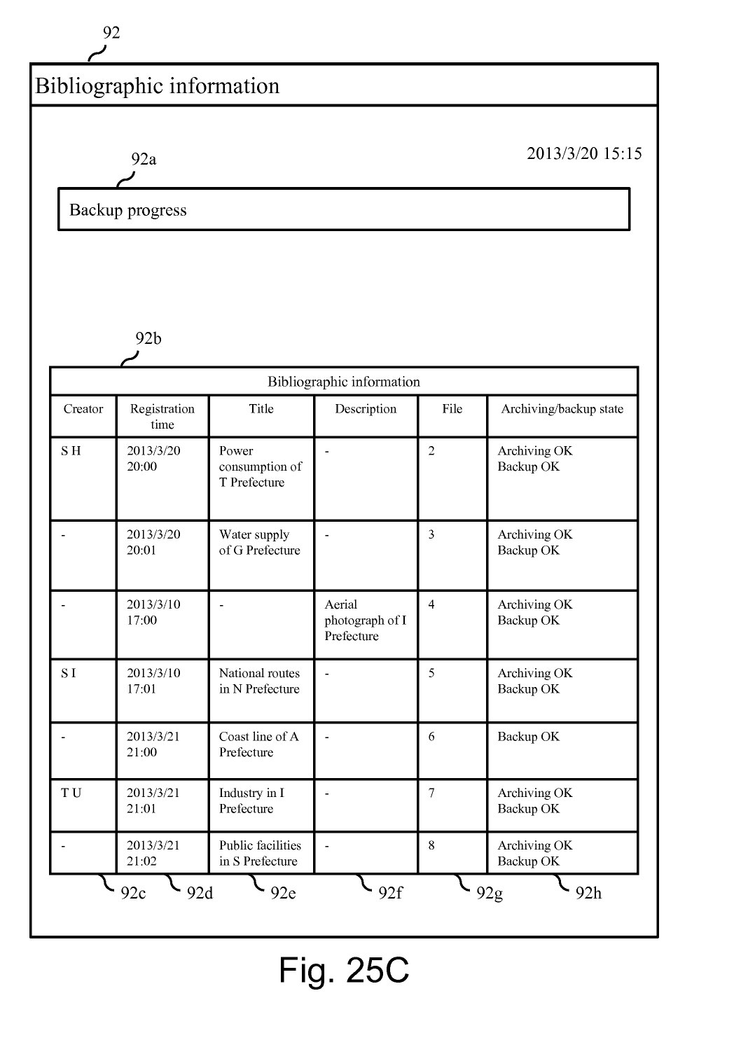

FIG. 25A is a configuration diagram of an example of an image list display screen according to the embodiment. FIG. 25B is a configuration diagram of another example of an image list display screen according to the embodiment. FIG. 25A shows an image list display screen at a certain time and FIG. 25B shows an image list display screen at a different time subsequent to the certain time.

An image list display screen 90 is a screen for displaying metadata of files and states of an archiving process/backup process and is displayed by the managing unit 131 of the file storage 1 when, for example, the managing unit 131 accepts an indication to display an image list display screen from a user (from the client 3 of the user) on, for example, a display apparatus of the client 3.

The image list display screen 90 includes a backup progress display area 90a and an image list 90b.

The backup progress display area 90a displays information representing progress of a backup process.

The image list 90b displays progress information of archiving/backup with respect to each tier of a tiered structure conforming to metadata for managing image files. In this case, the image list 90b shown in FIG. 25A represents an example where metadata of files is as shown in FIGS. 4A and 4B.

An image file is managed according to tiers of a patient, an inspection, a series, and an instance.

In the image list 90b, progress information of archiving/backup respectively corresponding to a patient tier 90c, an inspection tier 90d, a series tier 90e, and an instance tier 90f are displayed in a column of an archiving/backup state 90g.

The archiving/backup state 90g corresponding to an instance displays information indicating whether or not an image file that is the instance has already been archived. For example, when the image file has already been archived, the archiving/backup state 90g displays “archived”.

The archiving/backup state 90g corresponding to higher tiers such as a patient, an inspection, and a series displays a proportion of files already archived among the files included in the tier. Moreover, when a DB file has not been backed up, the archiving/backup state 90g displays information indicating that the information of the tier cannot be recovered from backup data (for example, “- - -”).

When an image list display screen is once again displayed upon lapse of a period of time after displaying the image list display screen 90 shown in FIG. 25A, the image list display screen 90 showing a state of an image list at that time point is displayed as shown in FIG. 25B.

An advantage of displaying this image list display screen 90 will be described below.

For example, a user may determine whether or not a file should be deleted at the client 3 when migrating an image file stored in the client 3 to the file storage 1. In such a case, the determination may conceivably be made based on image files stored in the file storage 1 or on whether or not the image file has been backed up. The image list display screen 90 enables a user to recognize such determination criteria in an easy and appropriate manner. In addition, the user can also be made aware of a backup state of higher tiers including image files.

FIG. 25C is a configuration diagram of an example of a bibliographic information display screen according to the embodiment.

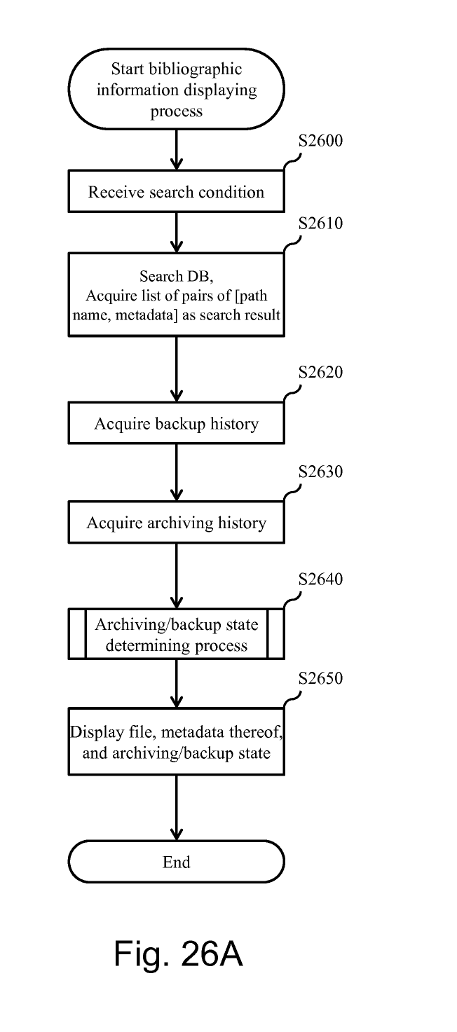

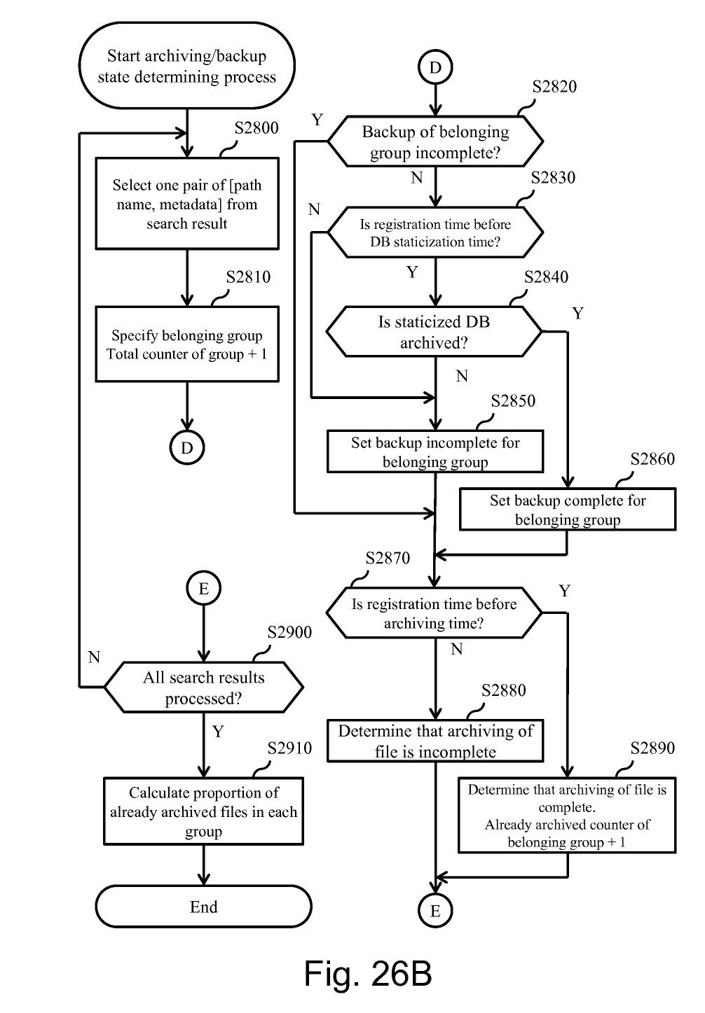

A bibliographic information display screen 92 is a screen for collectively confirming a content search result and states of an archiving process and a backup process when the AP unit 121 is a content management system that handles files of contents and is displayed by, for example, the managing unit 131 of the file storage 1 when accepting an indication to display bibliographic information from a user (from the client 3 of the user) by executing a bibliographic information displaying process (refer to FIG. 26A) on a prescribed display apparatus (for example, a display apparatus of the client 3).

The bibliographic information display screen 92 includes a backup progress display area 92a and a bibliographic information display area 92b.

The backup progress display area 92a displays information representing progress of a backup process.

The bibliographic information display area 92b displays information on a content in accordance with metadata for managing a content file. In this case, the bibliographic information display area 92b shown in FIG. 25C represents a case where the metadata of a file is as shown in FIG. 5B.

The bibliographic information display area 92b displays columns of a creator 92c, a registration time 92d, a title 92e, a description 92f, a file 92g, and an archiving/backup state 92h.

The creator 92c displays a value of the value 144c in an entry in which the attribute name 114b is a creator among entries in the metadata table 144 corresponding to the content. The registration time 92d displays a value of the value 144c in an entry in which the attribute name 114b is a registration time among entries in the metadata table 144 corresponding to the content. The title 92e displays a value of the value 144c in an entry in which the attribute name 114b is a title among entries in the metadata table 144 corresponding to the content. The description 92f displays a value of the value 144c in an entry in which the attribute name 114b is a description among entries in the metadata table 144 corresponding to the content. The file 92g displays a file ID of a file corresponding to the content. The archiving/backup state 92h displays information indicating whether or not a file corresponding to the entry has been archived and whether or not a DB file managing metadata of the file has been backed up. For example, when the file has already been archived, the archiving/backup state 92h displays “archiving OK”. In addition, when the DB file managing the metadata of the file has been backed up, the archiving/backup state 92h displays “backup OK”.

A user may conceivably determine whether or not a file of a content can be deleted at the client 3 depending on whether or not the file of the content has already been archived and may conceivably determine whether or not a DB file managing metadata of the file of the content has been backed up depending on whether or not an image file stored in the file storage 1 has already been backed up. The image list display screen 90 enables a user to recognize such determination criteria in an easy and appropriate manner.

FIG. 26A is a flow chart of a bibliographic information displaying process according to the embodiment.

The bibliographic information displaying process is executed when, for example, the managing unit 131 of the file storage accepts an indication to display the bibliographic information display screen 92 (or the image list display screen 90) from a user (the client 3 of the user). The display indication includes a search condition with respect to the file to be displayed. When displaying the image list display screen 91, examples of the search condition include “patient ID=P100”.

The managing unit 131 receives a search condition from the user (S2600), searches the metadata table 14b based on the search condition, and obtains a list of pairs of path names and metadata as a search result (S2610).

Next, the managing unit 131 acquires the backup history 119 and loads the backup history 119 to the memory 12 (S2620), and acquires the archiving history 118 and loads the archiving history 118 to the memory 12 (S2630).

Subsequently, the managing unit 131 executes an archiving/backup state determining process (refer to FIG. 26B) and determines states of archiving and backup (S2640).

Next, based on a file, metadata corresponding to the file, and information on states of archiving and backup corresponding to the file, the managing unit 131 displays an image list display screen 90 or a bibliographic information display screen 92 (S2650) and ends the bibliographic information displaying process. At this point, when displaying the bibliographic information display screen 92, the managing unit 131 displays backup OK in the archiving/backup state 92h if a state of backup to a group is not backup incomplete and displays archiving OK in the archiving/backup state 92h if the file has been archived.

FIG. 26B is a flow chart of an archiving/backup state determining process according to the embodiment.

The archiving/backup state determining process is a process corresponding to step S2640 in FIG. 26A.

The managing unit 131 of the file storage 1 selects one pair of a path name and metadata from the list that is the search result of step S2610 as a processing target (S2800), specifies a group to which the file belongs, creates a data structure corresponding to the group on the memory 12, provides a total counter for counting the number of files belonging to the group as an attribute of the data structure, and adds 1 to a value of the total counter (S2810). For example, when the internal application unit 121 is a medical image management system, patient IDs, inspection IDs, and series IDs respectively constitute groups. Moreover, when the internal application unit 121 is a content management system, it is assumed that one file constitutes one group for the sake of brevity.

Next, the managing unit 131 determines whether or not a state of backup of a belonging group is backup incomplete (S2820). As a result, when the state of backup of the belonging group is backup incomplete (S2820: Y), the managing unit 131 advances processing to step S2870.

On the other hand, when the state of backup of the belonging group is not backup incomplete (S2820: N), the managing unit 131 determines whether or not a registration time of metadata of a file that is a processing target in the metadata table 14b is before a latest staticization time in the backup history 119 (S2830). As a result, when the registration time of the metadata is before the latest staticization time (S2830: Y), the management unit 131 advances the process to step S2840, and when the registration time of the metadata is not before the latest staticization time (S2830: N), since this means that a backup has not been performed, the process is advanced to step S2850.

In step S2840, the managing unit 131 refers to the archiving history on the memory 12 and determines whether or not a DB file having been recently set as an archiving target is archived. As a result, when a DB file is not archived (S2840: N), the process is advanced to step S2850, and when a DB file is archived (S2840: Y), the process is advanced to step S2860.

In step S2850, the managing unit 131 makes a determination of backup incomplete for each belonging group and advances the process to step S2870.

In step S2860, the managing unit 131 makes a determination of backup complete for each belonging group and advances the process to step S2870.

In step S2870, the managing unit 131 determines whether or not a registration time of metadata of a file that is a processing target in the metadata table 14b is before a latest archiving trigger in the archiving history 118.

As a result, when the registration time of the metadata is not before the latest archiving trigger in the archiving history 118 (S2870: N), the managing unit 131 determines that archiving of the file is incomplete (S2880) and ends the process. On the other hand, when the registration time of the metadata is before the latest archiving trigger in the archiving history 118 (S2870: Y), the managing unit 131 determines that the file has been archived, adds 1 to the already archived counter of the belonging group (S2890), and advances the process to step S2900.

In S2900, the managing unit 131 determines whether or not processing has been performed on all pairs in the search result, and when processing has not been performed on all pairs in the search result (S2900: N), the managing unit 131 advances the process to S2800.

On the other hand, when processing has been performed on all pairs in the search result (S2900: Y), the managing unit 131 calculates a proportion of already archived files among the files belonging to each group using a value of the already archived counter (S2910) and ends the process. According to this process, a file corresponding to a path name and states of archiving and backup with respect to a group to which the file belongs can be determined.

While an embodiment has been described above, it should be obvious that the present invention is not limited to the described embodiment and that various modifications can be made without departing from the spirit and scope of the invention.

In the embodiment above, a method of backing up the database 14 by copying the DB files 112a and 112b to the first FS 114 and subsequently storing the copied DB files 112a and 112b in the archive storage 2 has been described. This method is an application of a method known as physical backup. Logical backup is also a known database backup method. In the present invention, logical backup can also be used in place of physical backup.

Specifically, while the DB files 112a and 112b are copied to the first FS 114 in S1020 (backup process of a database) in the embodiment described above, alternatively, a dump file of the database 14 may be generated and the dump file may be stored in the first FS 114 as backup data of the database 14. A dump file refers to data representing a logical structure of data specified by an entire database, a table, or a schema. In a similar manner to a DB file described earlier, a dump file is transmitted to the archive storage 2 and subsequently stubbed. In this case, in S2250 (restoring process of a database), instead of copying the DB files 112a and 112b from the first FS 114 to the second FS 111, the database 14 is to be restored by reading out the dump file and loading the dump file to the database 14.

By using a specific path name that enables the dump file to be distinguished as the path name of the dump file in the first FS 114, the dump file can be distinguished from other files stored in the first FS 114.

### REFERENCE SIGNS LIST

1 File storage
2 Archive storage
3 Client

1. A file storage apparatus coupled to a client computer and an archive storage apparatus, the file storage apparatus comprising:
a first file system;
a second file system configured to store a database including a database file;
an application unit configured to store a client file that is a file received from the client computer in the first file system and store metadata of the received client file in the database file;
a transmission file management information creating unit configured to create transmission file management information specifying files to be transmitted to the archive storage apparatus for archiving among a plurality of files which are stored in the first file system and which include a client file and a database file;
an archive processing unit configured to transmit a file specified by the transmission file management information to the archive storage apparatus at a prescribed archiving process start time;
a backup processing unit configured to back up a backup file of the database to the first file system at a prescribed backup process start time;
a consistency file management information creating unit configured to create consistency file management information specifying a backup file having been backed up to the first file system and a client file in the first file system at a time point when the backup file had been backed up; and
a consistency monitoring unit configured to monitor a file transmitted by the archive processing unit to the archive storage apparatus, to acquire, when a file specified by the consistency file management information is transmitted to the archive storage apparatus, data identification information for identifying the file transmitted to the archive storage apparatus in the archive storage apparatus, and to associate the acquired data identification information with the file specified by the consistency file management information.

2. The file storage apparatus according to claim 1, further comprising
a completion information transmitting unit configured to transmit, after the consistency monitoring unit detects that all files specified by the consistency file management information have been transmitted to the archive storage apparatus, completion information including file specification information that specifies a file with respect to each file specified by the consistency file management information, and data identification information that is associated with the file, to the archive storage apparatus.

3. The file storage apparatus according to claim 2, further comprising
a restore processing unit configured to receive the completion information from the archive storage apparatus, and based on the completion information, restore a backup file in the first file system and restore a file in the second file system.

4. The file storage apparatus according to claim 1, wherein
the archive storage apparatus is capable of managing data of a plurality of versions which correspond to a file, and
the data identification information associated with a file includes a data ID and a version number of the file.

5. The file storage apparatus according to claim 1, further comprising
an update monitoring unit configured to determine whether or not an update of a file specified by the consistency file management information has occurred, wherein
the backup processing unit is configured to, when the update monitoring unit detects that an update of a file has occurred, once again back up a backup file in the second file system to the first file system, and
the consistency file management information creating unit is configured to, when the update monitoring unit detects that an update of a file has occurred, once again create consistency file management information specifying a backup file having been backed up to the first file system and a file in the first file system at a time point when the backup file had been backed up.

6. The file storage apparatus according to claim 1, further comprising
a managing unit, wherein
the consistency monitoring unit is configured to associate transmission state information indicating whether or not a file specified by the consistency file management information has been transmitted to the archive storage apparatus, with the file specified by the consistency file management information, and
the managing unit is configured to display, based on the transmission state information, a state of progress of backup of the file specified by the consistency file management information.

7. The file storage apparatus according to claim 6, wherein
the managing unit is configured to display a state of progress of backup of the file specified by the consistency file management information in association with a group based on metadata of the file.

8. The file storage apparatus according to claim 1, further comprising
a managing unit configured to determine the backup process start time based on the archiving process start time.

9. The file storage apparatus according to claim 1, wherein
the backup file is at least one of the database file and a dump file of the database file.

10. A data management method of a file storage apparatus which stores a client file that is a file received from a client computer in a first file system and which stores metadata of the client file in a database file included in a database in a second file system, the data management method comprising:
backing up a backup file in the second file system to the first file system at a prescribed backup process start time;
creating transmission file management information specifying files which are backed up in the first file system and which are to be transmitted to an archive storage apparatus for archiving;
creating consistency file management information specifying a backup file having been backed up to the first file system and a file in the first file system at a time point when the backup file had been backed up;
performing an archiving process in which a file specified by the transmission file management information is transmitted from the first file system to the archive storage apparatus at a prescribed archiving process start time; and
acquiring, when a file specified by the consistency file management information is transmitted to the archive storage apparatus in the archiving process, data identification information for identifying the file transmitted to the archive storage apparatus in the archive storage apparatus, and associating the acquired data identification information with the file.

11. The data management method according to claim 10, wherein
after all files specified by the consistency file management information have been transmitted to the archive storage apparatus, completion information including file specification information that specifies a file with respect to each file specified by the consistency file management information, and data identification information that is associated with the file is transmitted to the archive storage apparatus.

12. The data management method according to claim 11, wherein
the completion information is received from the archive storage apparatus, and a backup file is restored in the first file system and a file is restored in the second file system based on the completion information.

13. The data management method according to claim 10, wherein
the archive storage apparatus is capable of managing data of a plurality of versions which correspond to a file, and
the data identification information associated with a file includes a data ID and a version number of the file.

14. The data management method according to claim 10, wherein
a determination is made on whether or not an update of a file specified by the consistency file management information has occurred,
when an update monitoring unit detects that an update of a file has occurred, a backup file in the second file system is once again backed up to the first file system, and
when the update monitoring unit detects that an update of a file has occurred, consistency file management information specifying a backup file having been backed up to the first file system and a file in the first file system at a time point when the backup file had been backed up is once again created.

15. The data management method according to claim 10, wherein
transmission state information indicating whether or not a file specified by the consistency file management information has been transmitted to the archive storage apparatus is associated with the file specified by the consistency file management information, and
a state of progress of backup of the file specified by the consistency file management information is displayed based on the transmission state information.
